(19) United States
(12) Patent Application Publication
(10) Pub. No.: US 2007/0240232 A1
(43) Pub. Date: Oct. 11, 2007

(54) Interactive Television System and Method

(76) Inventors: Angelo J. Pino, New York, NY (US); Peter M. Redling, Greensboro, NC (US); Mohammed Sattar, Belle Harbor, NY (US)

Correspondence Address: CAPITAL LEGAL GROUP, LLC, 5323 POOKS HILL ROAD, BETHESDA, MD, 20814, US

(21) Appl. No.: 11/697,499

(22) Filed: Apr. 6, 2007

Related U.S. Application Data
(60) Provisional application No. 60/789,932, filed on Apr. 7, 2006.

(51) Int. Cl. H04L 9/32

(52) U.S. Cl. 726/28

(57) ABSTRACT

A method and system for providing television programming content and interactive data services is provided. In one embodiment, the method uses a plurality of communication devices disposed in a plurality of customer premises and that are configured to display television programming content on a display, to receive user inputs, and to receive interactive data. In one embodiment, the method comprises storing user account information for a plurality of user accounts, including account identifying information, in a memory; receiving user profile information of one or more user profiles from a plurality of the communication devices and wherein each user profile information includes one or more content selections associated with a user account. The method may further include storing each of the received user profile information in memory in association with a user account, receiving a request for content from a communication device, determining first content based on the content selections stored in memory associated, and transmitting the first content to the communication device. In addition, the method may include pulling content and receiving pushed content and storing the content in memory. The content may be transmitted as an alert, as ticker content, or other interactive display.

### CROSS REFERENCE TO RELATED APPLICATIONS

This application claims priority to U.S. Provisional Patent Application Ser. No. 60/789,932, filed Apr. 7, 2006, which is incorporated herein by reference in its entirety.

### FIELD OF THE INVENTION

The present invention generally relates to an interactive television system and method. Specifically, various embodiments of the present invention provide real-time, or near real-time select information to the user in response to a user request, user profile information, alert information, ticker information, user location information, and/or other information.

### BACKGROUND OF THE INVENTION

With the advent of Digital Television (DTV) comes the ability to create interactive TV (ITV) programming. The “old” analogue set-top box cable units are being phased out and replaced by more robust digital units. Digital cable head-ends and their supporting infrastructure have made it possible to create and deploy TV applications. These applications allow the viewer to call up movies on demand, play games, record TV programs, etc.

Cable companies are now migrating towards applications that allow them to take advantage of a key consumer function—transactions. Unlike the Internet, the cable systems are “closed” to the public, acting much more like an Intranet. This creates a much more secure environment for transactions to take place.

In instances when transactions are subject to an “approval” by a third party financial source (i.e., Verisign®), a secure direct connection may be established between the transacting company and the cable company via a private communication link.

The public has, over the years, grown quite accustomed to wagering on such things as the state lottery and scratch-off games. These two revenue sources have helped numerous states raise much needed revenues. The key to the success of these platforms has been convenience. For example, most consumers can go to his or her corner convenience store to play these games.

On the other hand, a consumer who wants to take advantage of wagering on horses, must do so either through an Off-Track Betting (OTB) branch or by telephone. This lack of convenience poses obstacles to the participation of the public in horse wagering. OTB branches are shrinking in number due to the high cost of maintaining those operations, and phone wagering is something that the general public has never warmed up to.

The home cable TV system alleviates the barriers that most consumers face when feeling the urge to wager on a horse racing. First, using the set top box to place wagers is convenient and secure. Second, because most cable subscribers are comfortable using their remotes to navigate channels and services, selecting menus and clicking to make a wager is both transparent and comfortable to the consumers.

Because the existing infrastructure of the cable companies can handle millions of potential wagers, there is very little cost in using that infrastructure to facilitate a television based (set top box based) wagering. In addition, the current OTB infrastructure is very costly to build out and maintain. The cost of human operators and their inherent support network can impact revenues immensely. Thus, while there may always be a need for this transaction layer, dependency on it can be vastly reduced through a TV based wagering platform. One or more embodiments may overcome

Television broadcast and cable systems have largely been broadcast systems in which each user receives the same content. However, combining the interactive data with television programming would allow the user to receive content that the user can identify as being of interest to that user and also receive content from a plurality of sources such as the internet and television program providers.

One or more embodiments of the present invention may overcome the disadvantages of the prior art and/or supply additional benefits over the prior art.

### SUMMARY OF THE INVENTION

The present invention provides a method and system for providing television programming content and interactive data services. In one embodiment, the method uses a plurality of communication devices disposed in a plurality of customer premises and that are configured to display television programming content on a display, to receive user inputs, and to receive interactive data. In one embodiment, the method comprises storing user account information for a plurality of user accounts, including account identifying information, in a memory; receiving user profile information of one or more user profiles from a plurality of the communication devices and wherein each user profile information includes one or more content selections associated with a user account. The method may further include storing each of the received user profile information in memory in association with a user account, receiving a request for content from a communication device, determining first content based on the content selections stored in memory associated with the user account, and transmitting the first content to the communication device. In addition, the method may include pulling content and receiving pushed content and storing the content in memory. The pushed and pulled content may be transmitted as alert content, ticker content, or other interactive display.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates a network implementing an example embodiment of the present invention;

FIG. 2a provides a navigation schematic according to an example embodiment of the present invention;

FIGS. 2b-h illustrate example interfaces for receiving user information according to an example embodiment of the present invention;

FIG. 2i illustrates an example ticker according to an example embodiment of the present invention;

FIG. 2j illustrates an example alert according to an example embodiment of the present invention;

FIG. 2k illustrates an example implementation of processes for providing content according to an example embodiment of the present invention;

FIG. 3a provides a navigation schematic of the news feature according to an example embodiment of the present invention;

FIGS. 3b-g illustrate example interfaces for receiving user inputs and providing news content according to an example embodiment of the present invention;

FIG. 4a provides a navigation schematic of the weather feature according to an example embodiment of the present invention;

FIGS. 4b-g illustrate example interfaces for receiving user inputs and providing weather content according to an example embodiment of the present invention;

FIGS. 5a-q illustrate example interfaces for receiving user inputs and providing sports content according to an example embodiment of the present invention;

FIGS. 6a-e illustrate example interfaces for receiving user inputs and providing financial content according to an example embodiment of the present invention;

FIGS. 7a-e illustrate example interfaces for receiving user inputs and providing real estate content according to an example embodiment of the present invention;

FIGS. 8a-g illustrate example interfaces for receiving user inputs and providing information of a plurality of restaurants content according to an example embodiment of the present invention;

FIGS. 9a-i illustrate example interfaces for receiving user inputs and providing content relating to a wagering platform according to an example embodiment of the present invention; and

FIG. 10 illustrates an example interface for navigating to one or more channels according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, set top boxes, cable television systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, set top boxes, cable television systems, communication systems, computers, terminals, devices, components, techniques, data and network protocols, software products and systems, operating systems, development interfaces, and hardware are omitted so as not to obscure the description of the present invention.

System Architecture and General Design Concepts

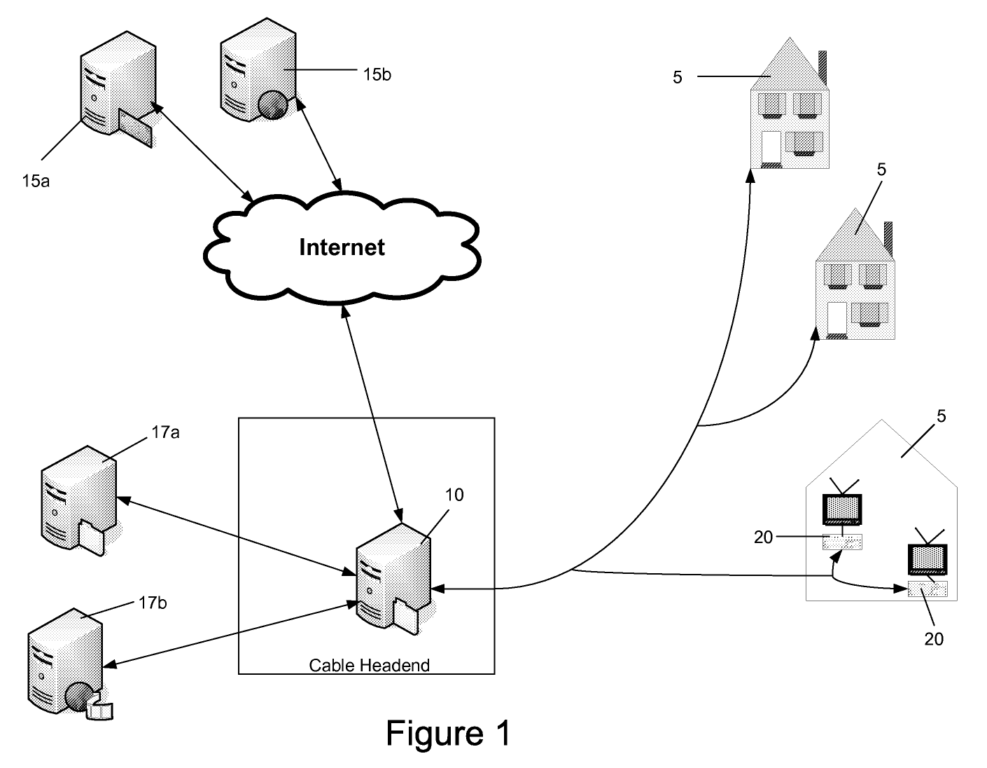

The present invention may provide real-time, or near real-time specific information to the user in response to a user request, user profile information, user location information, and/or other data. As shown in FIG. 1, a server 10, which may be connected to or co-located at the cable provider head-end, may be communicatively coupled to a plurality of set top boxes 20 (located in a plurality of customer premises 5) via the cable provider's telecommunication infrastructure (e.g., coaxial cable network or fiber coaxial hybrid network).

The server 10 may also be coupled to one or more servers 15 via a public communication medium such as the Internet. In addition, the server 10 may be coupled to one on or more servers 17 via a private link (e.g., such as a virtual private network, a PSTN, or via a dedicated communication link). The servers 15 and 17 may supply content (e.g., news, advertising, etc.) and also be configured to receive and transmit responses to requests (hereinafter referred to as interactive content) from server 10. The interactive content may be, for example, a response to a request from the server 10 (which may be provided to the server 10 from the user via a user request, user profile information, user financial information, user alert information, user ticket information, etc.) to provide specific information of interest to the user. Specific information, may include, for example, a stock quote, an alert related to a specific event, a sports score for a specific team, sport, or game, and other data illustrated in the figures and described below.

The server 10 may be a computer system comprising a conventional web server (e.g., serving HTML pages to the set top boxes 20) and, therefore, include a computer system with a processor, memory, server software, and application software for execution to perform the functions of the present invention. The memory of the server 10 may be co-located with other portions of the computer system or be remote and may be centralized or distributed. The memory of the server 10 may store a plurality of screens (e.g., HTML screen files), advertisements, user data, user profile data, set top box identification (ID) information, and other information. For example, in one embodiment, each set top box has a unique identification code (ID) that may be associated with a zipcode (or other location information) and the user profile information of one or more users in a particular household. Each of the one or more users of a set top box may provide user profile information, which may be stored in memory of the server 10 (e.g., in a user database). Requests and other transmissions to the server 10 from the set top box 20 may include the set top box ID (which allows the server to determine the location of the user (e.g., either zip code or address) by looking up the set top box ID number in memory). Knowing the location of the user may thus allow for localized advertising or the selection of advertising based on the user's location. In addition, in residences where there is only one user, the set top box ID also allows the server to access the user database to determine the user's profile, ticker, and alert selections for that user.

The set top boxes 20 may also include software such as HTML client software for displaying the screens (e.g., HTML files) transmitted by the server 10 and for transmitting information (e.g., requests, responses, etc.) in response to inputs from the user. In one embodiment, the set top boxes 20 receive user inputs from the user via a remote control although any suitable input device may be used such as a keyboard, mouse, touch screen, etc. The set top box 20 may then transmit information of the input to the server 10.

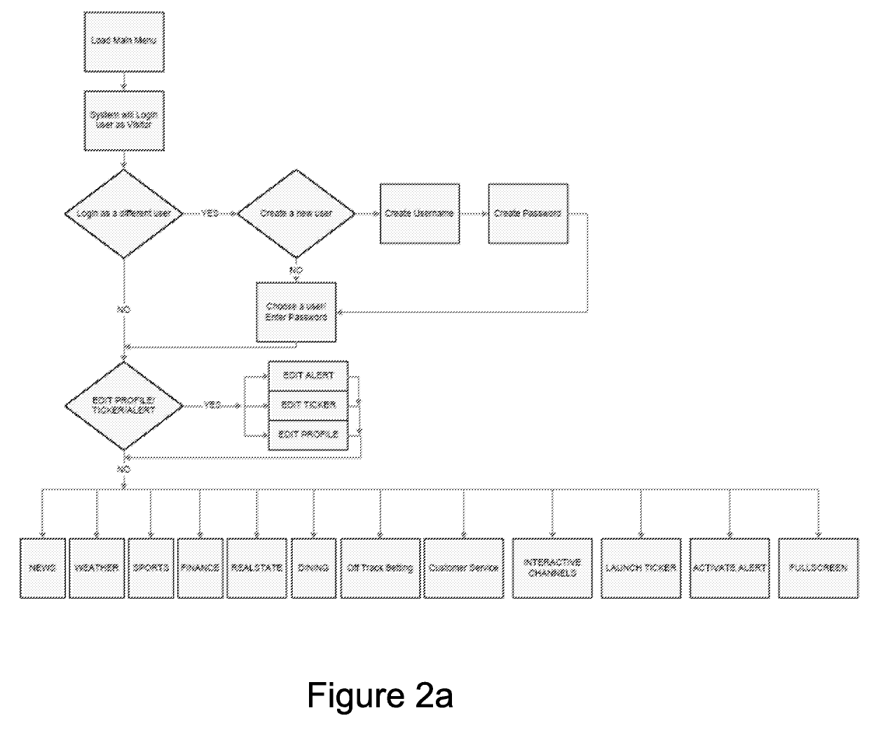

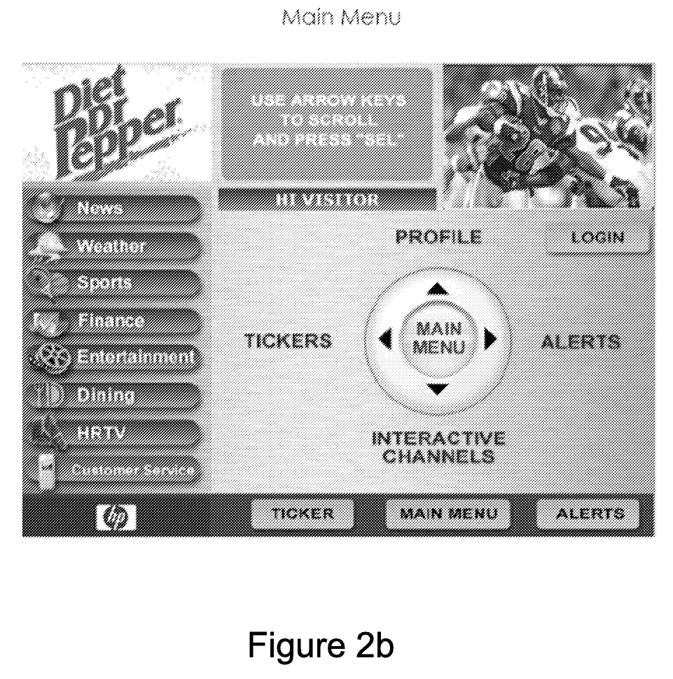

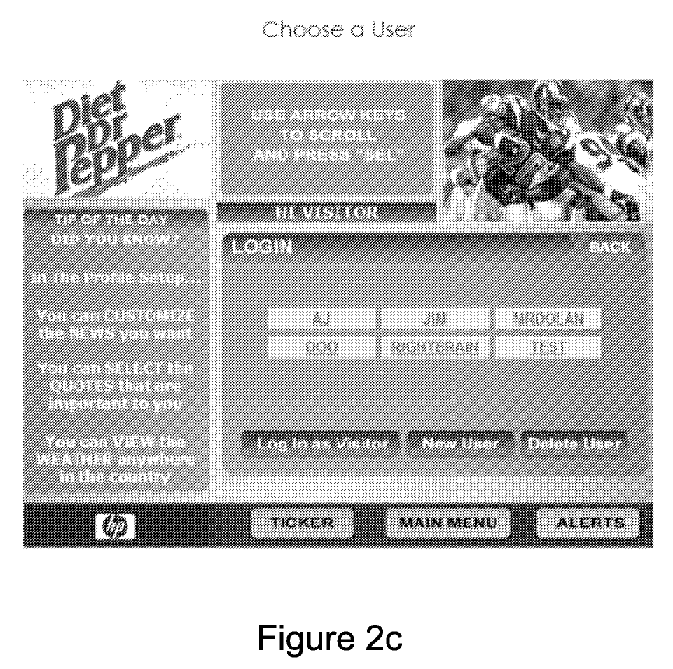

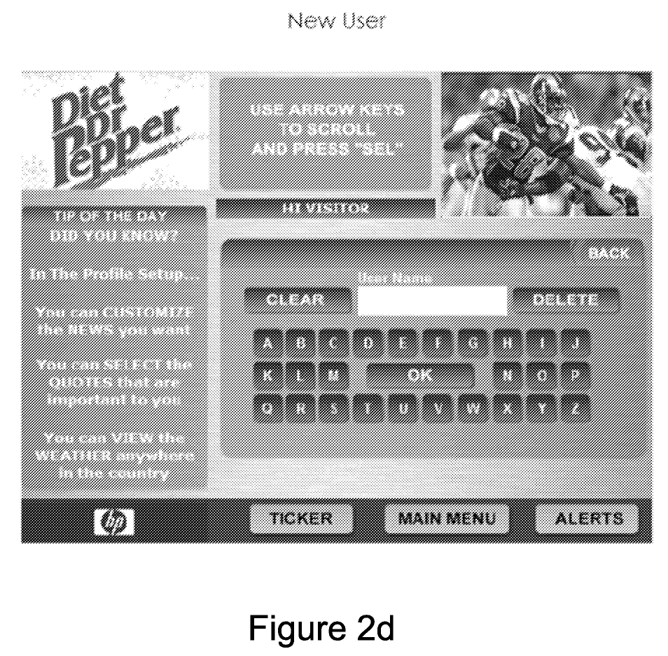

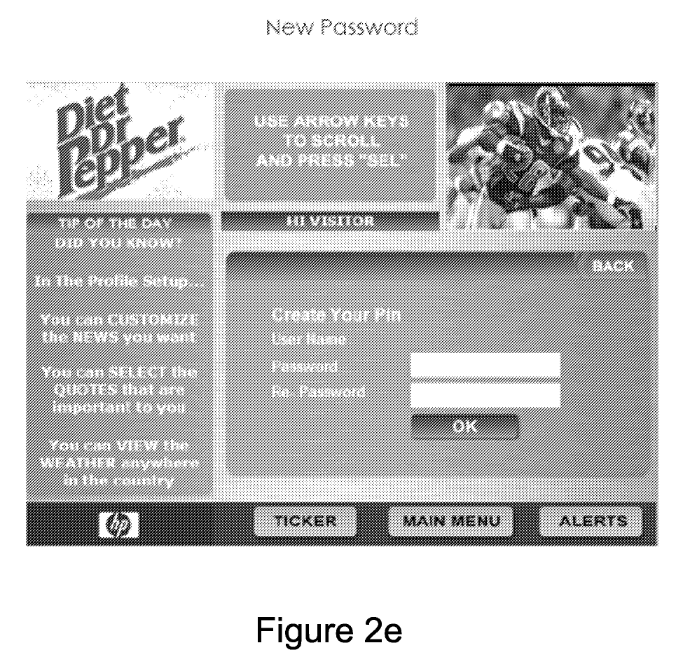

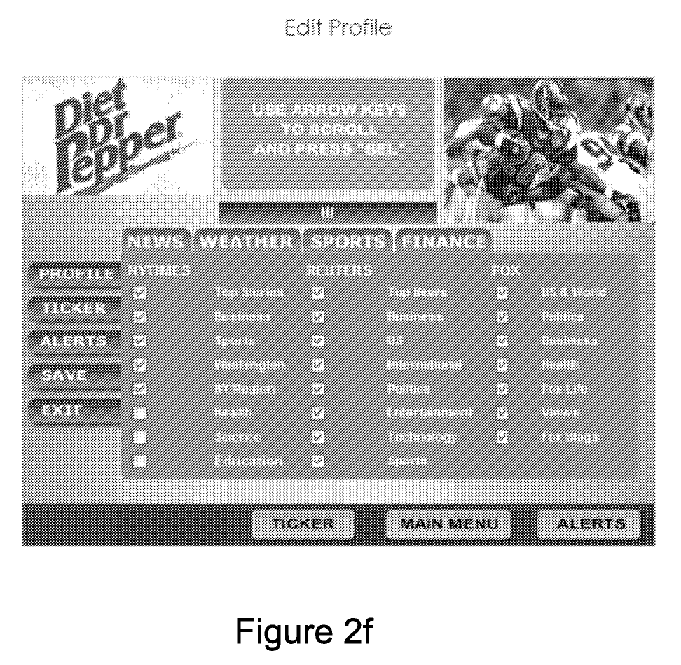

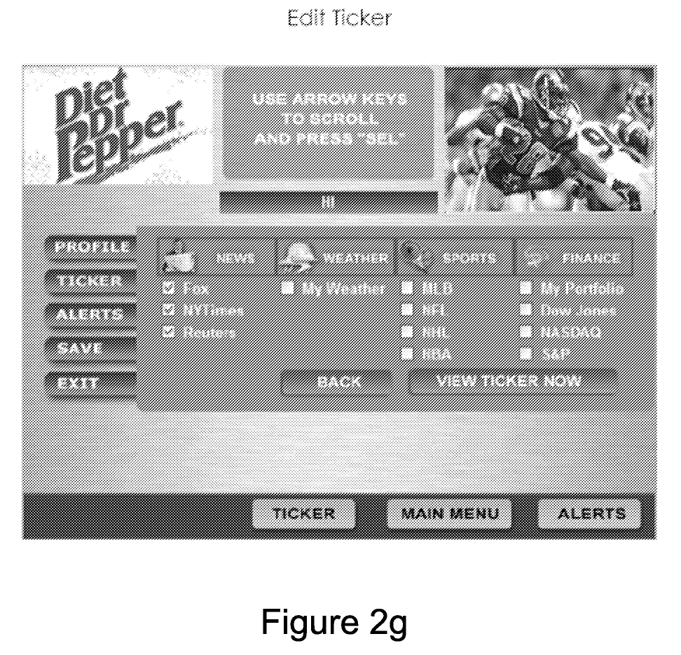

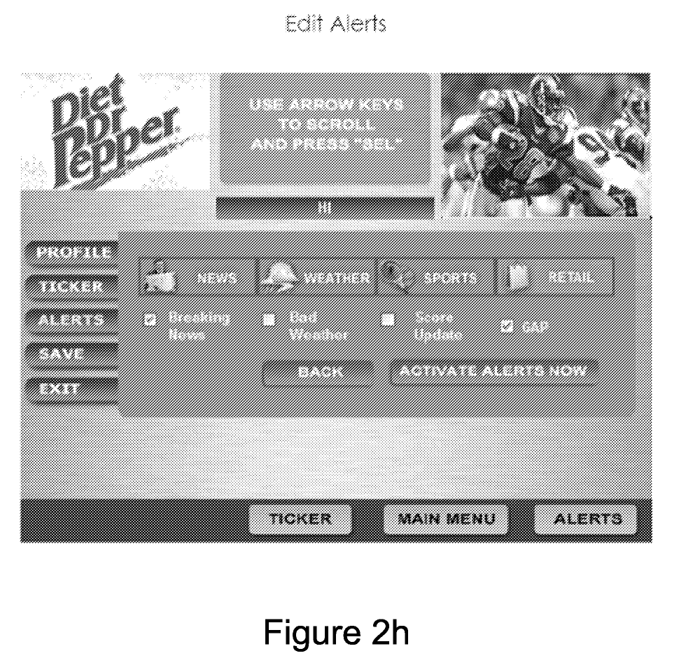

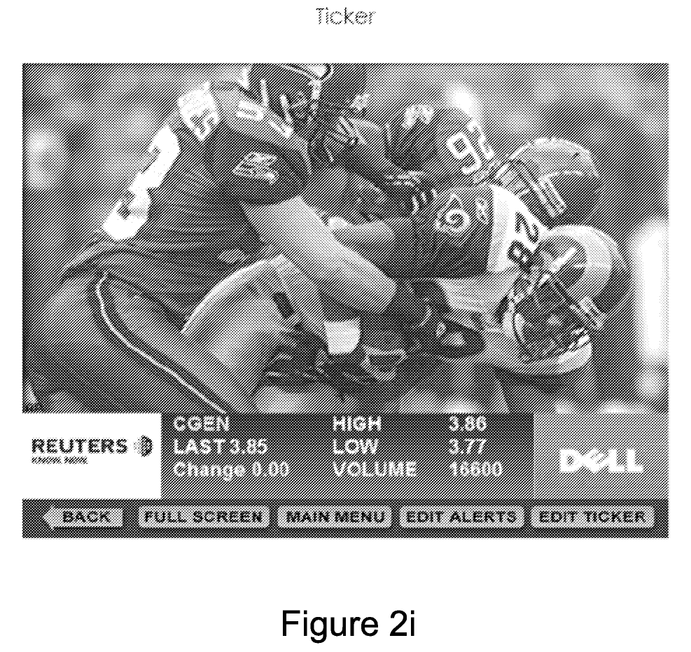

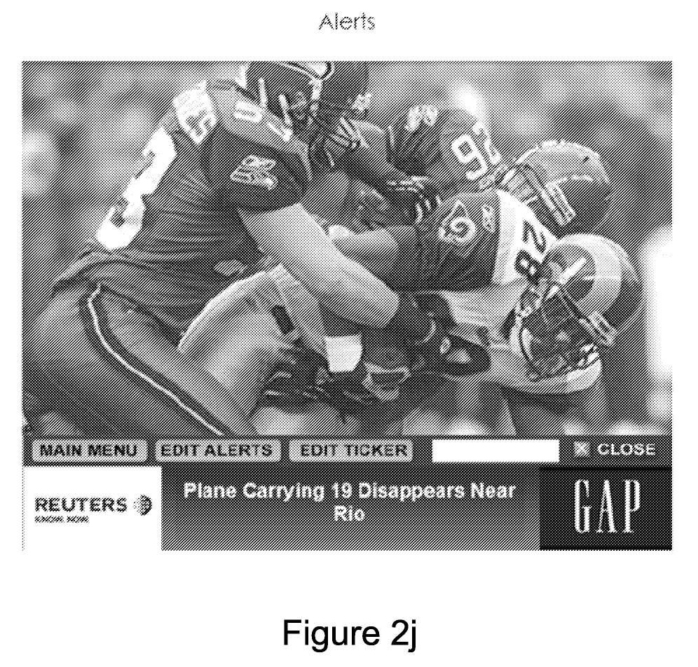

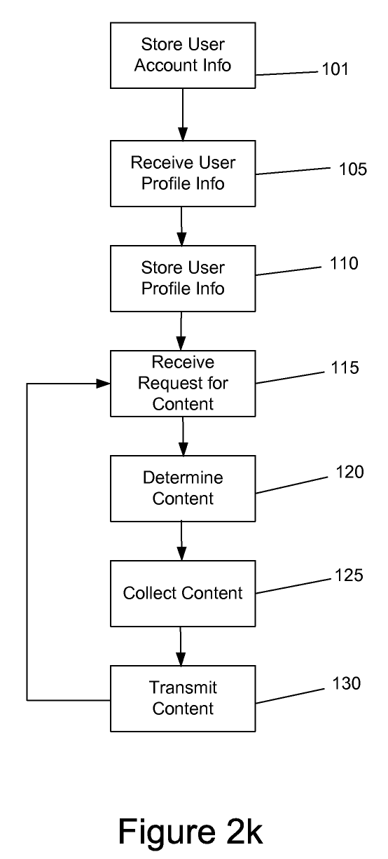

Referring to FIGS. 2a and 2b, the user may select any of a plurality of content via the main menu as well as provide or view user profile information, alert information, and ticker information. FIG. 2a illustrates an example of how the user may navigate through the screens. Specifically, FIG. 2c shows a screen that allows the user to add a new user, delete a user, or login by providing information to the server indicating which user (in that household) is using the set top box 20. Specifically, using the remote control, the user can hi-light and click on any listed user, log in as a visitor, select New User, or Delete a User. FIG. 2d illustrates a screen for allowing a person to create a new user. It is worth noting that one person may create numerous system user accounts, with each typically having at least some different information. FIG. 2e allows the new user to create a pin (or password). The data from the screens shown in FIGS. 2d and 2e is transmitted from the set top box 20 to the server 10 to be stored in the user database in memory (in association with the set top box ID). Thus, the user database of the server 10 may include multiple user accounts associated with a single set top box. It is worth noting that the television programming continues to be presented to the user (displayed in the upper right corner along with audio) to allow the user to continue to watch and hear the audio-video content while the user views interactive content, supplies information, and makes requests. Upon creation of a new user account, the server 20 (or set top box) may assign a user ID (e.g., an identifying user number), which is included in transmissions from the set top box 20 for that user account so that the server 20 can determine which of a plurality of user accounts is requesting or supplying data.

FIGS. 2f, 2g, and 2h allow the user to supply information for his or her user profile, ticker information, and alert information, respectively. Specifically, FIG. 2f provides an example interface that allows the user to provide user profile information by allowing the user to select one or more categories of news from a plurality of new sources. While FIG. 2f only shows a list of news sources and topics from which the user may select, other user profile information may include user selectable weather information, sports information, and finance information as well as subcategories of each type content category. For example, the user may select sports as a category and football as a subcategory. In other embodiments, the user profile information may additionally include a list of favorite television channels, television programs, and/or other content or data selections. The user profile data may be transmitted by the set top box 20 to the server 10 for storage in the user database (associated in memory with the user account) and may be used to select content and advertising for transmission to the user's set top box and/or account.

In addition, the user may also supply additional information about the user such as the user's age, sex, location information (e.g., zipcode, address, county, state, area code, telephone number, etc.), income information, special interests (e.g., hobbies), birth date, year of birth, employment information (e.g., field of employment, position, title, etc.), ethnicity, marital status, parental status (i.e., how many children), and other data—collectively referred to herein as user data. The user data may be transmitted by the set top box 20 to the server 10 for storage in the user database (associated in memory with the user account) and may be used to select content and advertising for transmission to the user's set top box.

FIG. 2g provides an interface to allow the user to supply ticker information. In this example embodiment, the user may select one or more subcategories (e.g., Dow Jones, NASDAQ, etc.) of content from any of a plurality of categories (e.g., Finance) as well as one or more news sources (e.g., from which to receive news content) and one or more advertisers (not shown).

FIG. 2h provides an interface to allow the user to supply alert information. In this example embodiment, the user may select one or more categories of alerts as well as one or more advertisers (e.g., the Gap®). In other embodiments, the user may select one or more categories of content such as, for example, finance, sports, world, and/or national news as the categories of content about which the user wishes to receive breaking news content (alerts). In addition, the user may select one or more news sources from which to receive breaking news content.

The ticker data and the alert data is transmitted from the set top box to the server 10 (along with the set top box ID and/or user ID) for storage in the user database (associated in memory with the user account).

The user may select and display ticker content or alert content while he or she is watching television programming. FIG. 2i shows an example ticker that is inserted under the television programming. The television programming may be “resized” to allow the ticker to be displayed, along with the full broadcast signal (television program). In other embodiments the ticker may overlay a portion of the television programming. In this example, the user is watching a football game (the television programming) and the set top box 20 is displaying a ticker at the bottom of the television screen. The ticker of this example provides content related to a particular stock, although content associated with any of the categories or sources in FIG. 2g or other information could be shown. The ticker may display a plurality of specific pieces of content (hereinafter content elements) over time. Specifically, each content element has different information and will typically be displayed for a predetermined time period (e.g., five seconds) at which time the HTML client resident on the set top box 20 will display a new content element. Thus, the set top box 20 will receive a plurality of ticker content elements (identified in a ticker list) from the server 20 for display via the ticker. The ticker list and plurality of ticker content elements are stored in the memory of the set top box 20. The HTML client resident on the set top box 20 will rotate through the plurality of content elements displaying each ticker content element for a time, followed by the next, until all are displayed at which time the ticker contents elements are displayed again from the beginning of the ticker list.

When the user turns on the set top box 20 (or sometime thereafter), he or she may activate the ticker feature causing the ticker to be displayed (as shown in FIG. 21) and causing the set top box 20 to periodically transmit requests for new ticker data. The server 10 may respond by transmitting new data, if new content is available. Thus, the ticker content (and ticker list) may be updated by the receipt of new content elements transmitted from the server 10. For example, even though the user does not take action to request new data, the set top box 20 will continue to transmit (periodically, aperiodically, or intermittently) an indication that the ticker feature is activated, and the server 10 will receive the indication and access the user database to identify, and transmit ticker content elements for that user (e.g., transmit the specific stock content selected by the user on the ticker input interface as shown, for example, in FIG. 2g) if new ticker content is available. As new content is received, the oldest content may be removed from the ticker list and no longer displayed via the ticker. When the user turns off the ticker function, the set top box 20 stops transmitting requests for ticker data and stops displaying the ticker content.

Instead of activating the ticker feature, the user may elect to display alert content while he or she is watching television program by activating the alert feature. FIG. 2j shows an example alert that is inserted under the television programming. The television programming may be “resized” to allow the alert to be displayed, along with the full broadcast signal (television program). In other embodiments the alert may overlay a portion of the television programming. In this example, the user is watching a football game (the television programming) and the set top box 20 is displaying an alert at the bottom of the television screen. The alert content is displayed for a relatively short period of time when new content is received. The alert content information may supplied to the server 10 by another server 15, 17 and transmitted to all the set top boxes for which the type of alert has been previously selected by the user. The alert, of this example, provides information of a particular news alert although information associated with any of the topics or sources in FIG. 2h or other information could be shown. In other embodiments, the television programming may be made smaller (compressed vertically) and the alerts and/or tickers placed at the bottom so that the entire television program is visible. In still another embodiment, the tickers and/or alerts may comprise semi-transparent overlays.

When the user turns on the set top box 20, he or she may activate alerts, which causes the set top box to periodically transmit requests for new alert data. The server 10 may respond by transmitting new alert data, when new alert content is available. While the alert is activated (and until de-activated; i.e., turned off), newly received alert content is displayed on the television display for a predetermined time period after receipt and then removed by the set top box 20. The newly received alert content is displayed while the user is watching television programming so as to allow the user to continue watching the television programming. Thus, even though the user does not take action to request new alert data, the set top box 20 will continue to transmit an indication that the alert feature is activated, and the server 10 will receive the indication and access the user database to identify new alert content (i.e., the content sources, categories, sub-categories and specific content to be provided for the particular user) and transmit the new alert content elements for that user (e.g., transmit the content of the specific content categories selected by the user on the alert input interface) if new alert content is available.

While there may be many set top boxes 20, only a subset of the total number of set top boxes will be turned on and have the alert or ticker function activated. Thus, in one example embodiment, each of the activated set top boxes periodically (e.g., every ten seconds, one minute, three minutes, five minutes, fifteen minutes, thirty minutes, or sixty minutes) transmits a request for alert content or ticker content. In one implementation, the request may be a generic request that includes data sufficient to identify the (1) the user account; (2) the set top box (e.g., in the instance where there is only one user profile associated with the set top box); or (3) the set top box and user (e.g., where there is more than one user profile associated with the set top box). The request also may include information to indicate what content is needed (ticker content or alert content). The ticker data and alert data previously supplied by the users and stored in the user database accessible by the server 10 indicates the variety of content to be provided to the set top boxes 20. Specifically, stored in memory in the database, and associated with each user account (or, alternately, with each set top box where there is only one user per set top box), is information of the ticker and alert content selected by that user. The server 10 receives the requests from the set top boxes 20, and information (e.g., user ID or set top ID) that allows the server 10 to access the database to retrieve information to determine what content to be provided to the activated set top boxes. Thus, upon receiving of a request for content, the server 10 accesses the user database to retrieve information of the specific content to be provided to the activated set top boxes (or user thereof) from whom the request is received. In another embodiment, the requests for ticker and alert content is logged (stored in memory) and the server periodically (e.g., every five, ten, fifteen, or thirty minutes) identifies, collects, and transmits the new content to the requesting set top boxes 20.

In this example embodiment, there are two methods of obtaining the content for the plurality set top boxes 20. A first method—referred to herein as “pulling the data”—includes transmitting a request for the data. As an example, the user database of the server 10 may include the stock symbols selected by all the users having activated alerts and/or tickers. While this may be a large number of symbols, it may still be a much smaller number than the total number of stock symbols of the financial markets. Consequently, instead of transmitting a request for all stock symbols (or receiving all the symbols periodically) the server 10 may transmit request(s) for only those stock symbols in its user database for those set top boxes that are activated for alerts and/or tickers. Similarly, the server 10 may pull the data (transmit a request for, and receive the data) for other types of content such as weather (by requesting weather for geographical areas of activated set top boxes), news, and other content.

While the server 10 will periodically (and continuously) receive requests for ticker data and alert data, depending on the embodiment the server 10 may transmit requests for new content less frequently than the server 10 receives requests from set top boxes 20. Thus, in some respects, the request from the set top boxes 20 that have the ticker feature or alert feature activated may be considered a ticker ping or alert ping (that includes user account and/or set top box identifying data) that informs the server that the set top box 20 is awaiting new content when it is available. In addition, if no new content is available after receiving a request (either because it is too early to request new content or no new content has occurred yet (e.g., no new breaking news stories), the server 10 may not respond with any message or may respond with a notification that there is no new content available.

Another method of obtaining content includes receiving pushed data. Specifically, when the amount of content from a provider typically is not too large, the content provider (e.g., server 15 or 17) may periodically push the content to the server 10 (i.e., transmit the new content to the server 10 without the server 10 transmitting a new request for the content). As example, all sports content may be pushed to the server 10 and stored on the server according to the type and/or category of sports content (e.g., football, baseball, etc.). The server 10 retrieves and transmits the specific categories of sports content to each activated set top box 20 according to the categories of content stored in the user database (as selected by the user). For example, only those users who have selected football content will receive football ticker or alert content. The content transmitted to the set top boxes 20 may be transmitted via broadcast, multi-cast, or unicast methodologies depending on the embodiment.

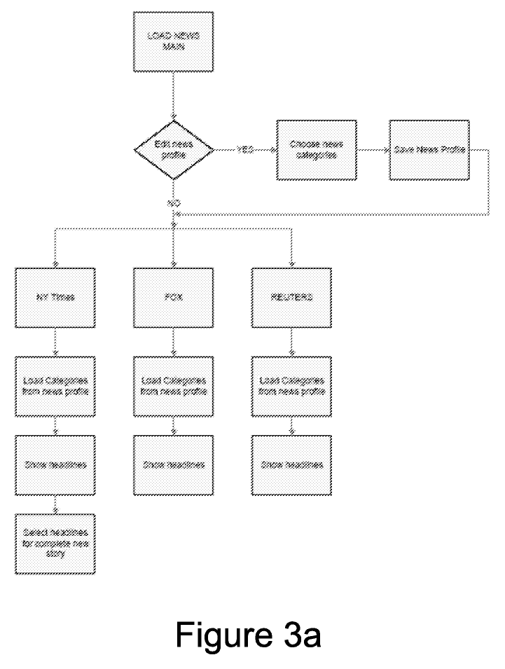

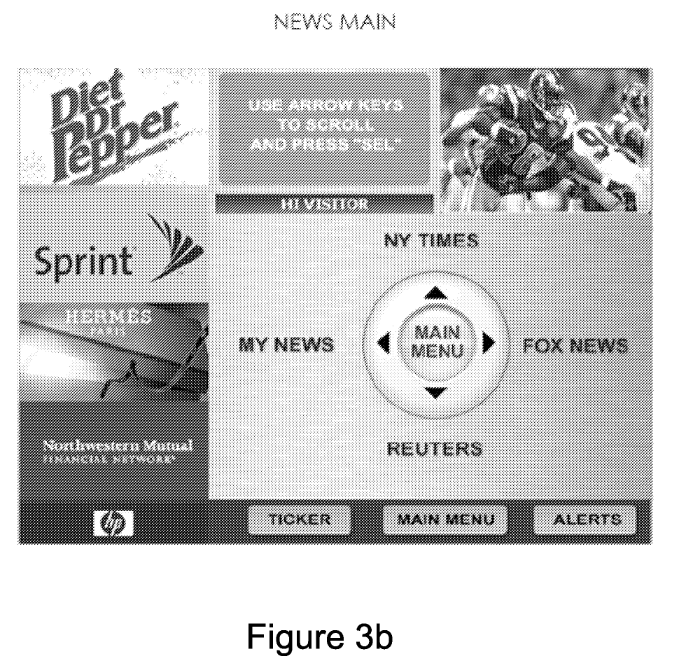

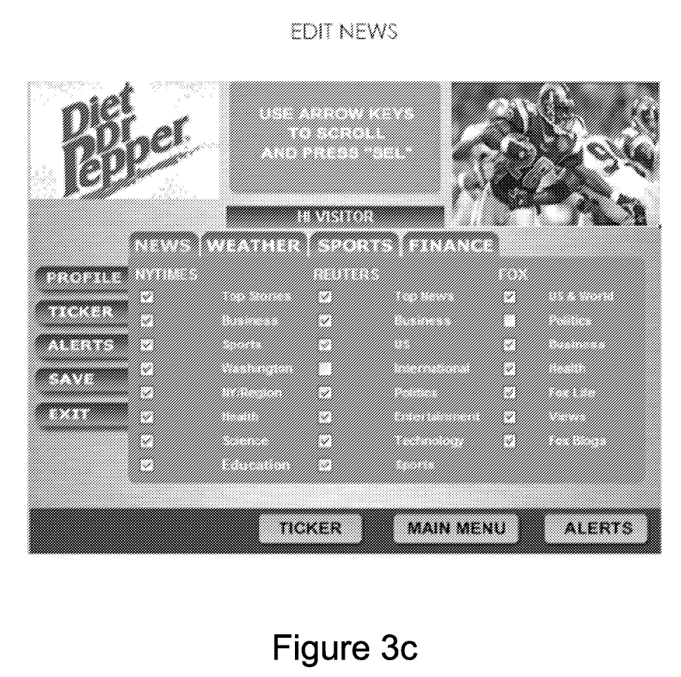

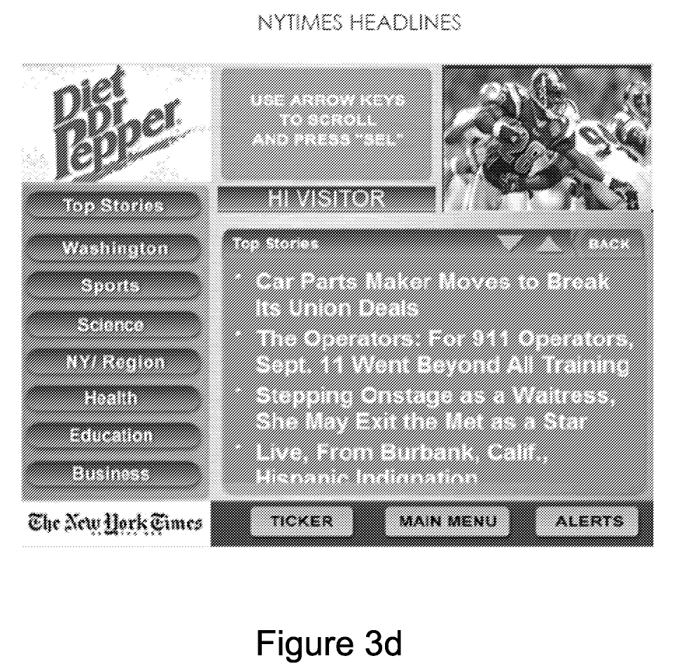

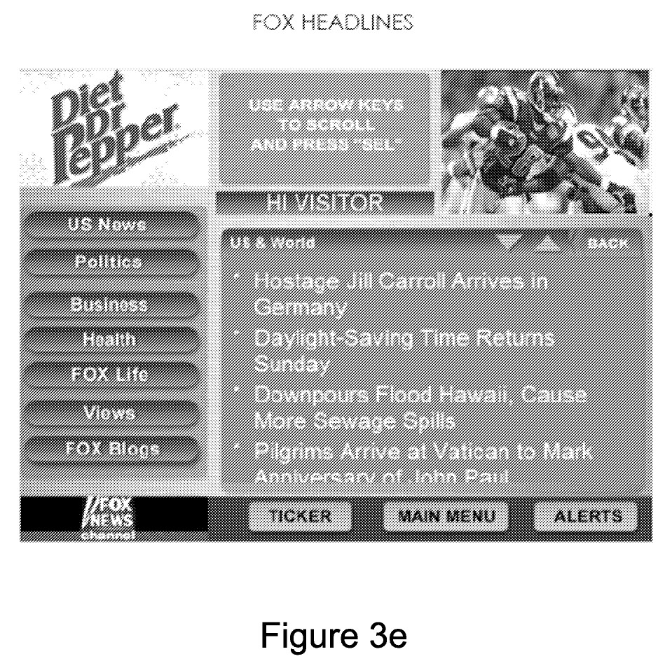

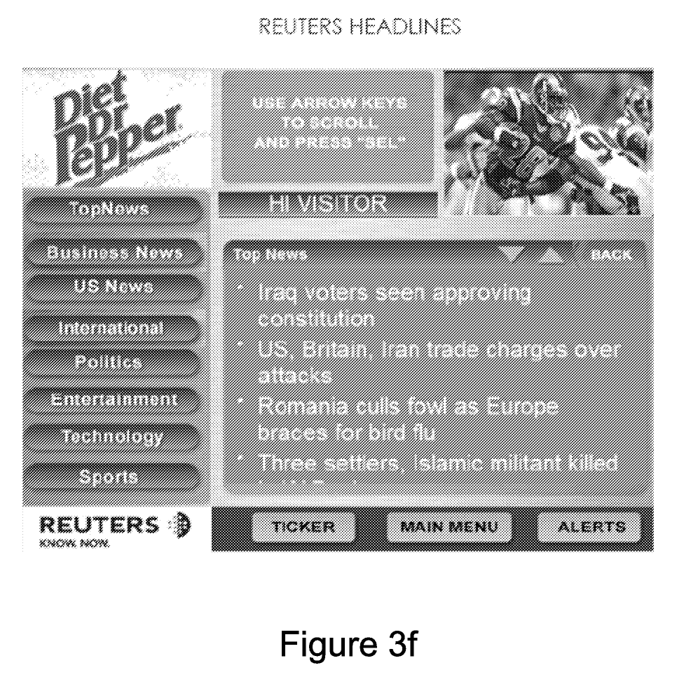

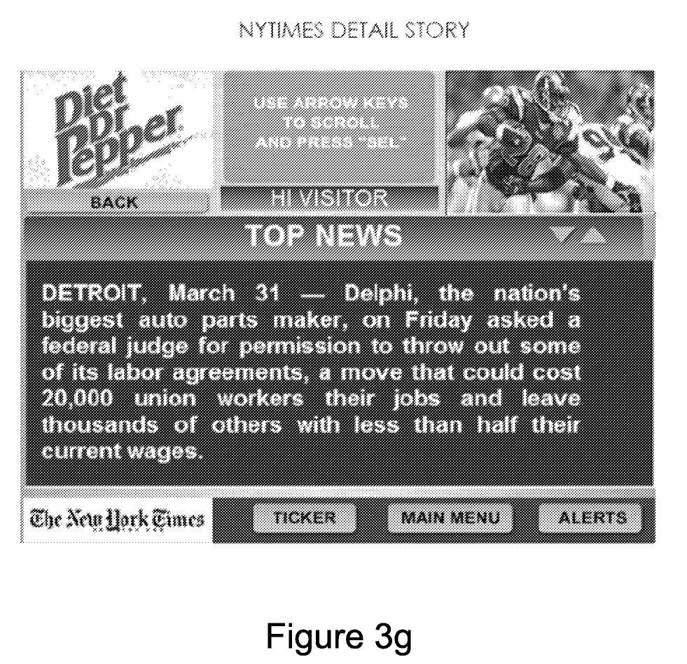

FIG. 2k illustrates the processes of an example implementation for providing content to a plurality of set top boxes. The user account information received from one or more set top boxes is stored in memory at the server 10 at process 101. This information may include, for example, a user name and password. The user account information, in some embodiments, may be stored in the memory in association with a set top box 20 (meaning the user account data is stored so that the server 10 can determine the set top box that the user account). In some embodiments, the user account may be associated with multiple set top boxes (e.g., where one household has multiple set top boxes). In other embodiments, the user account is associated with a customer (e.g., a customer number, address, phone number, or other identifying information). At process 105, the server 10 receives user profile information, which in one embodiment may include information identifying content sources (e.g., new sources), categories of content (e.g., sports), sub-categories of content (e.g., football), and/or other such content information. The user profile information is stored in the memory in association with the user account at step 110. At process 115, the server 110 receives a request for content for example, via one of the interfaces of FIGS. 3a-f. The request may identify the user account, the set top box, the interface (screen) from which the user is making the request, and/or other data. At process 120, the server 10 may then determine the content to be transmitted to the set top box 20 by accessing the user database and retrieving (from memory) the content in accordance with the content selections supplied by the user via the user profile interface. At process 125, the needed content is collected, which may include retrieving content from memory (which may be pushed content), and/or transmitting a request for and receiving the content (i.e., pulling the content). The content is then transmitted to the set top box for presentation to the user at process 130.

FIGS. 2b-2j and other figures herein illustrate that the screens may include advertisements (e.g., Dell®, Gap®, and Diet Dr. Pepper® shown in the figures). Such advertisements may be selected by the server 10 (from a database of advertisements) based on user profile information, location information (e.g., zipcode), user information, programming selected by the user, and/or other information. New advertisements may be received and displayed by the set top box 20 periodically and/or intermittently as part of a ticker, alert, or other interactive interface. The user may click on an advertisement to get more information about the product (which may be displayed on a subsequent screen or sent via email or postal mail) and/or to purchase an advertised product (e.g., via a subsequent screen). Specifically, when the user selects an advertisement (via the remote control or other input), the set top box transmits a request for the next screen, which may be informative (and provide more information), allow purchase of an item, cause additional information to be transmitted to the user via another method (e.g., email, postal mail, text message, etc.), and/or facilitate other interactivity.

FIG. 3a illustrates how the user may navigate through the news screens of an example embodiment. FIG. 3b illustrates the main news interface, which allows the user to begin navigation through the various interfaces that provide the news content selected by the user via the User Profile interface. FIG. 3c provides a screen to allow the user to edit the user's news profile information (which is transmitted to the server 10 for storage in the user database). Data from this interface will be written over the data in the user database previously provided by that user. FIGS. 3d-f show headlines from different news sources. The headlines and news sources may be selected by the server 10 based on information in the user's news profile in the user database stored on the server 10. Thus, the server 10 may select and transmit news content in accordance with the news profile information provided by the user and stored in the user database of the server 10. The user may select a particular headline from any screen to get more information such as that shown in FIG. 3g. Upon selection of a news source or headline, the set top box 20 transmits a request (e.g., along with the user ID or set top box ID as is needed) for the desired content. The server 10 responds by retrieving the requested content (e.g., from memory or from another server 15, 17) and transmitting the content to the set top box 20 for display to the user. Again, the user may request and view news content while watching and listening to television programming as illustrated.

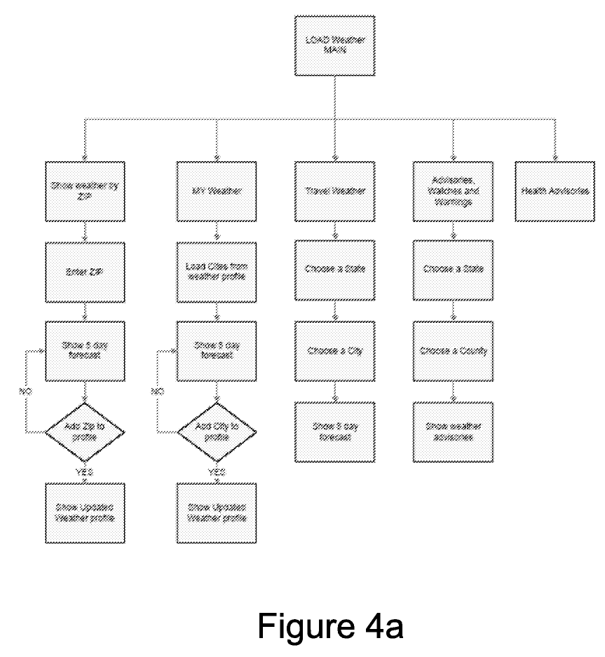

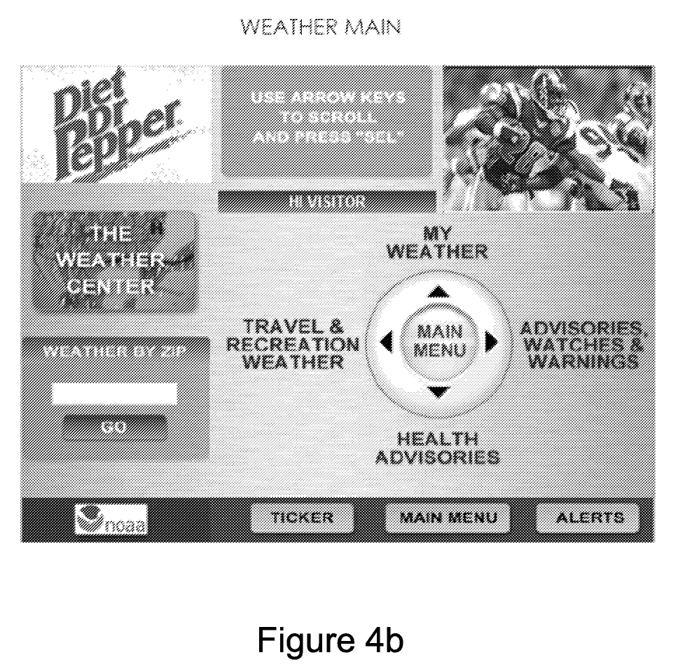

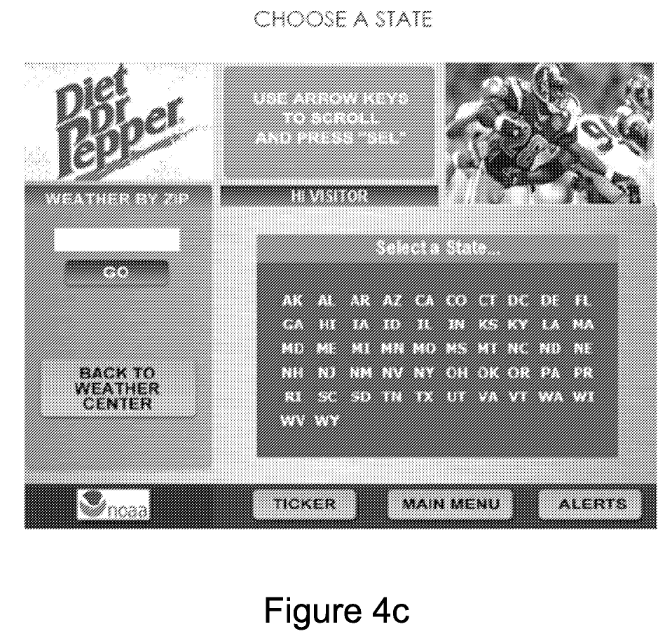

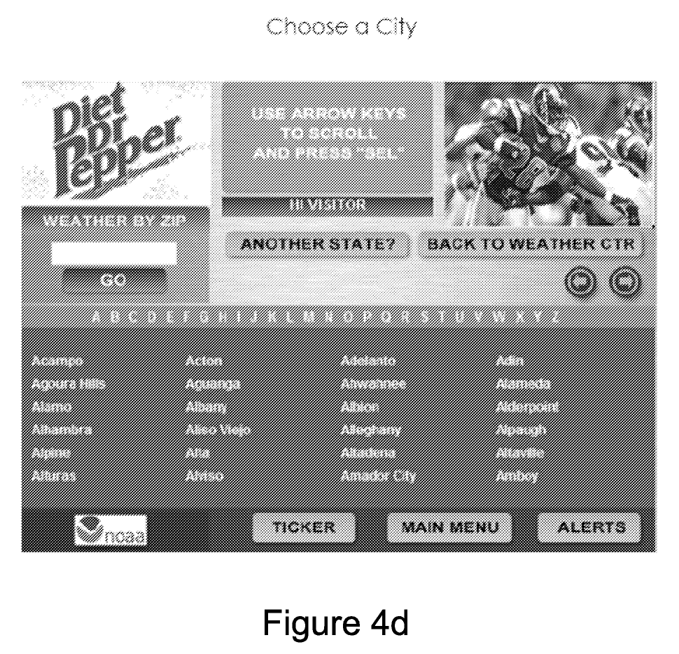

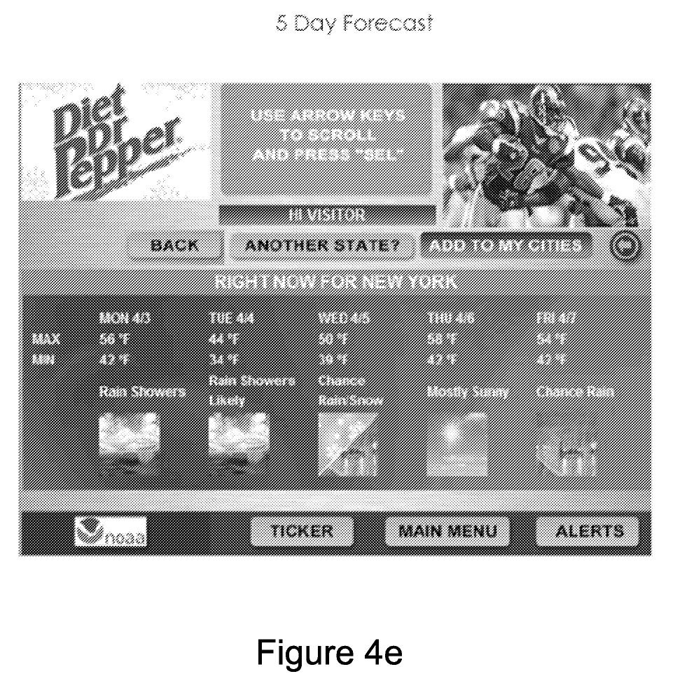

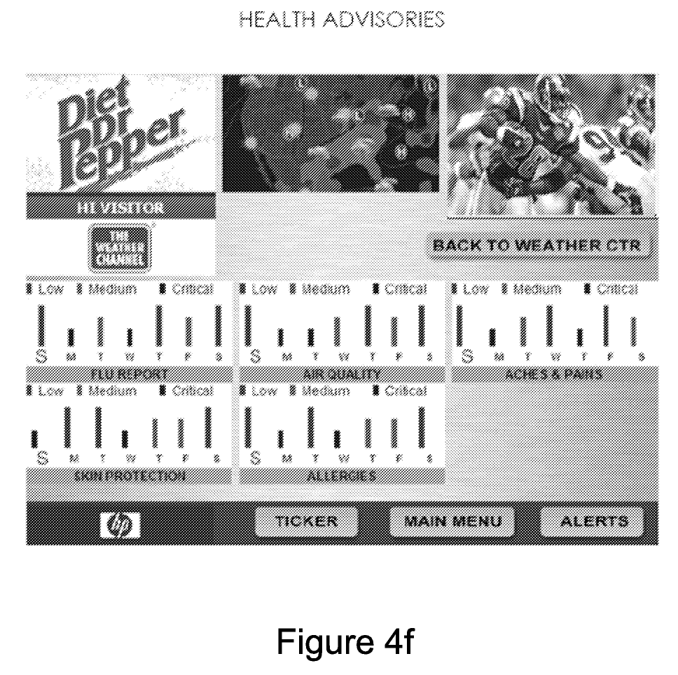

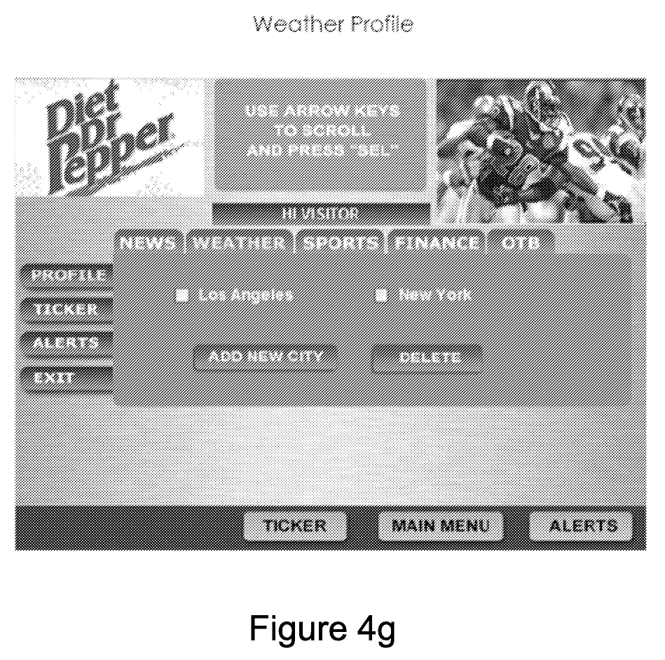

FIG. 4a illustrates how the user may navigate through the weather screens of an example embodiment. As shown in FIGS. 4a-4g, the user may select to receive weather information based on various information such as zip code, city, state, and/or county and may also select to receive health advisories as shown in FIG. 4f (which may or may not be directly weather related (e.g., information related to the flu, pollen, etc.)). The user's weather selection information may be transmitted to the server 10 for storage in the user database. The server 10 may then select and transmit weather information in accordance with the weather selection information provided by the user.

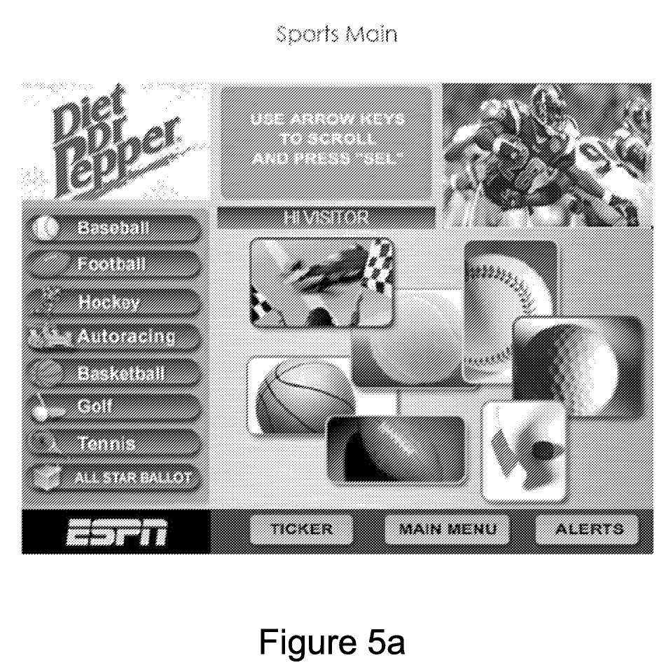

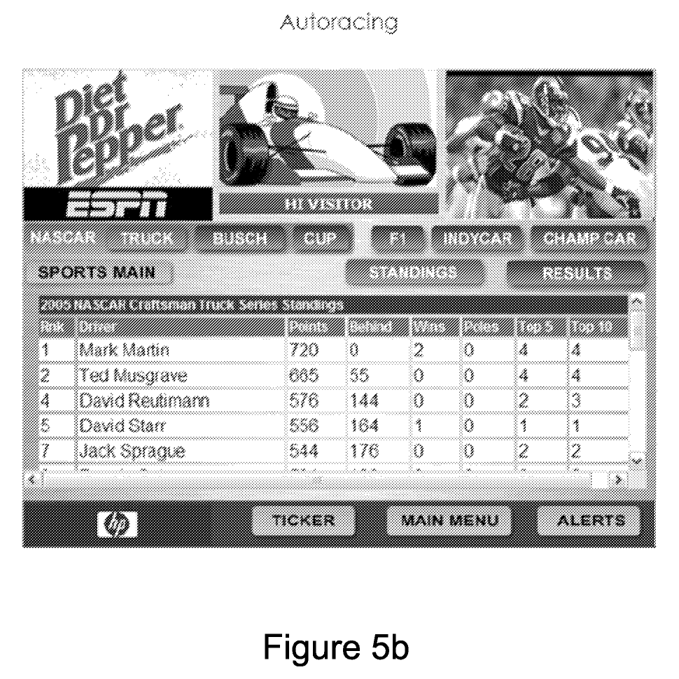

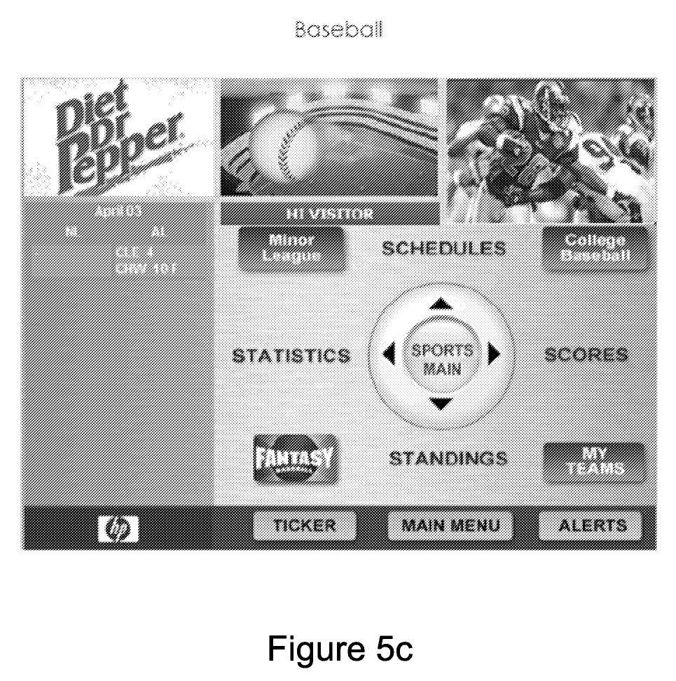

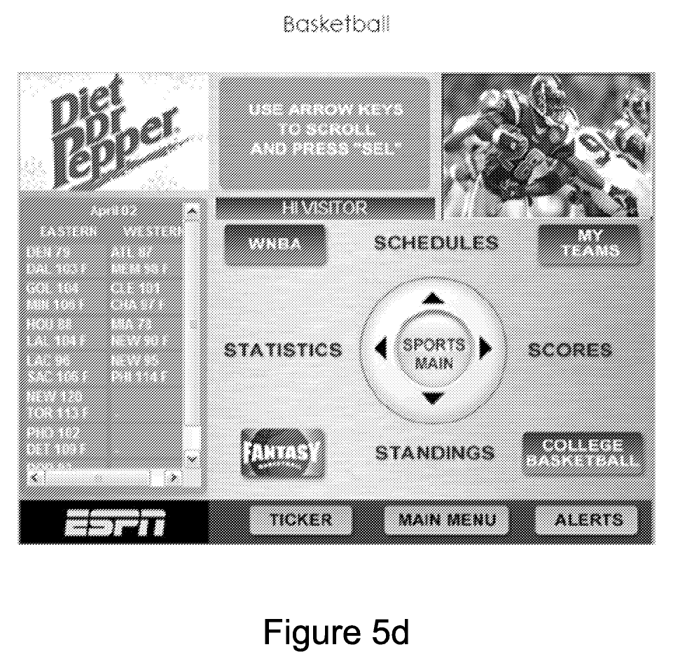

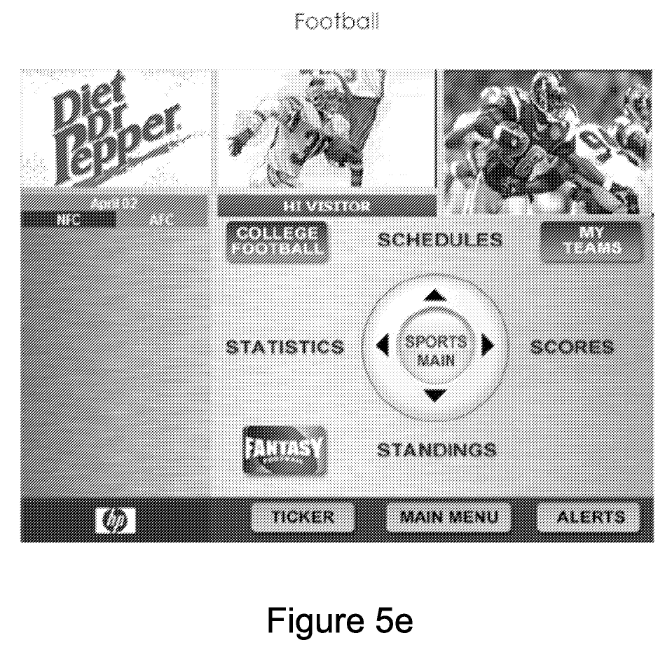

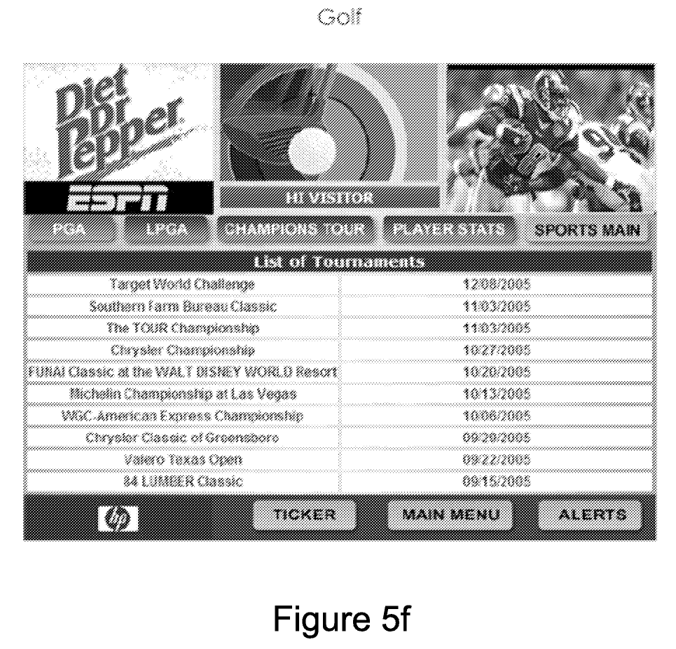

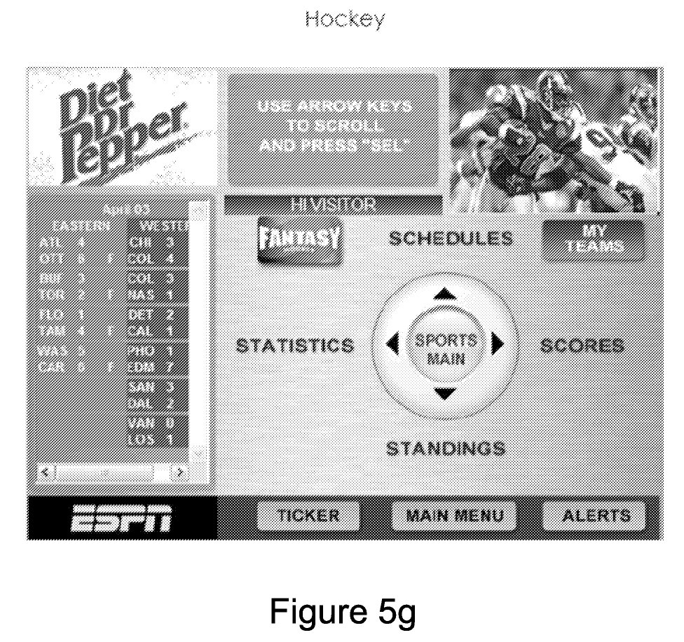

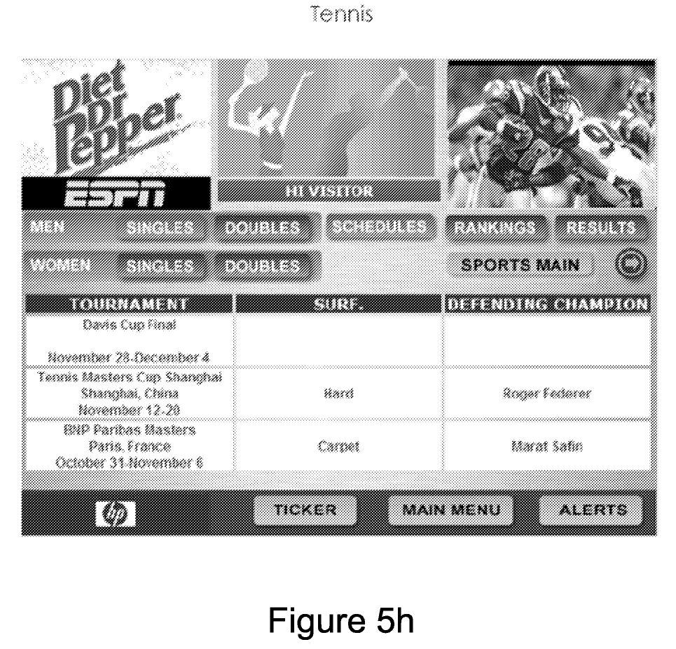

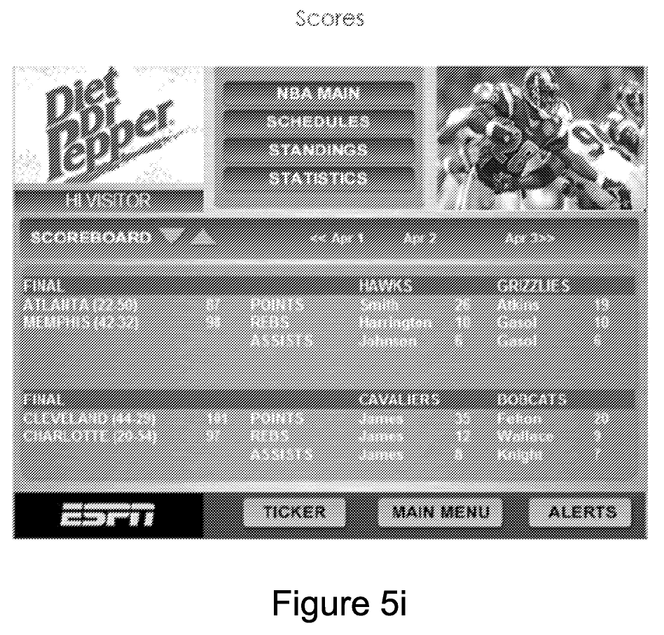

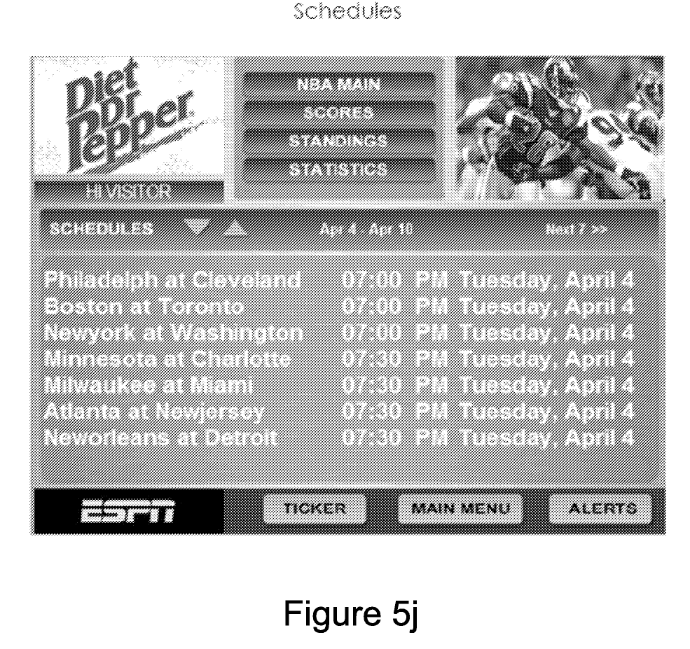

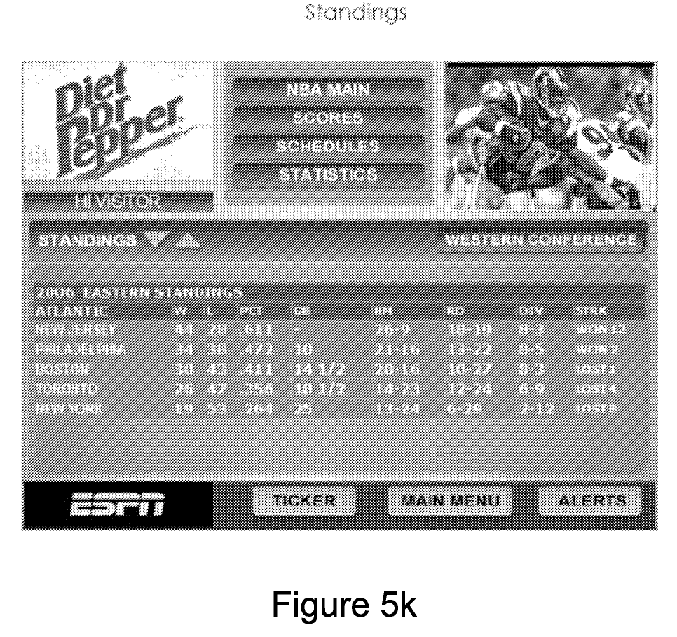

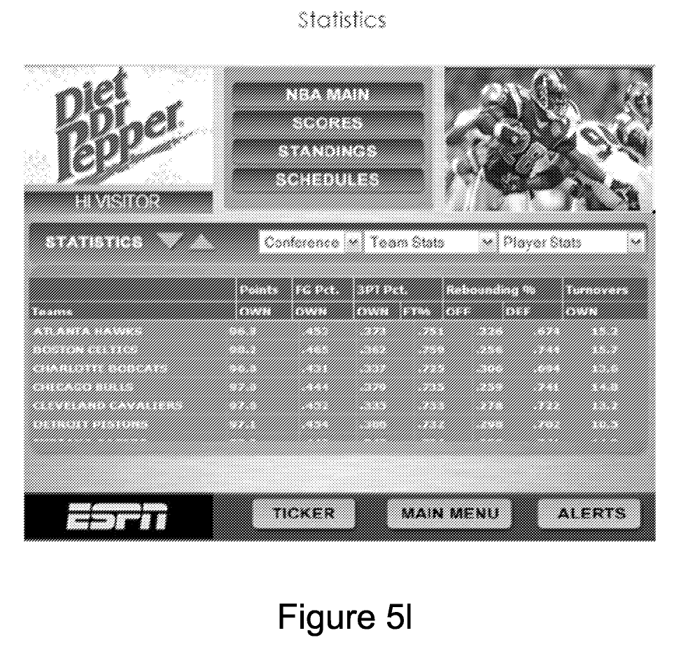

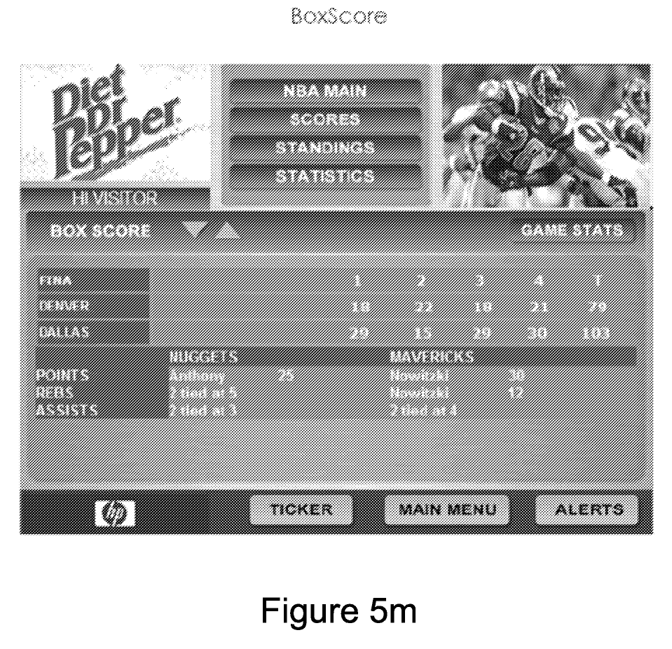

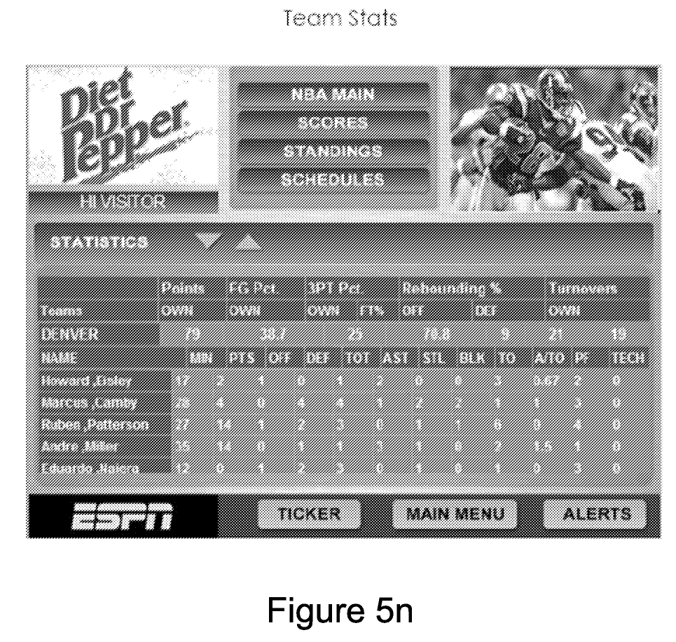

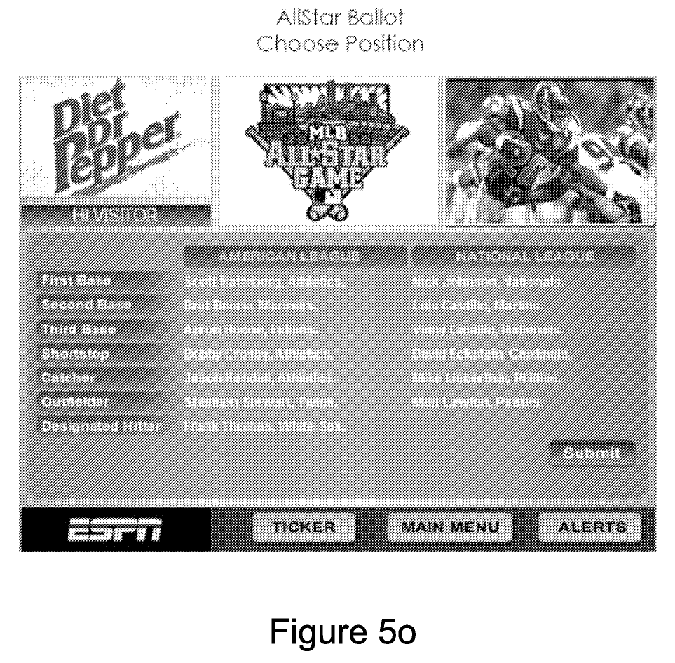

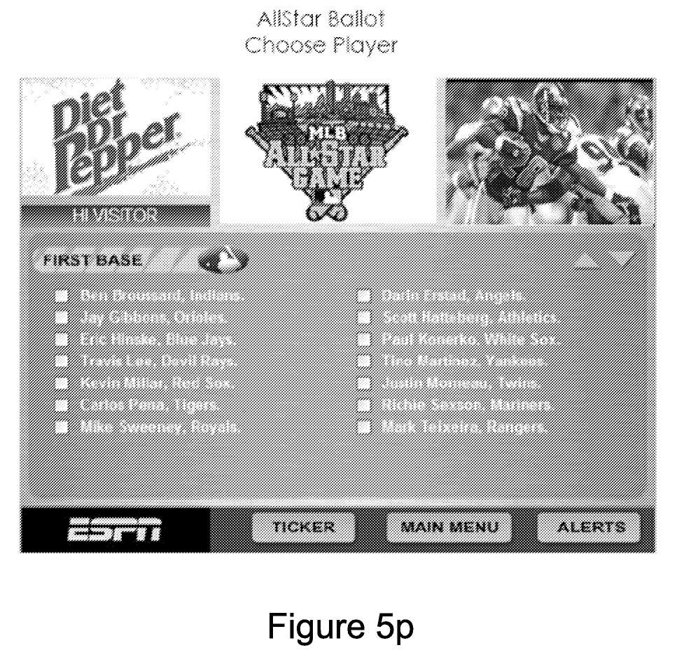

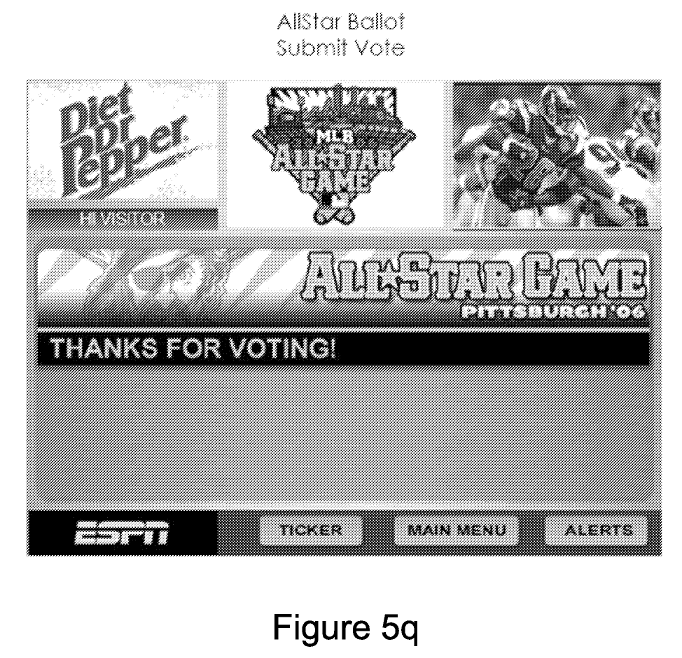

FIGS. 5a-q show how the user may navigate through the sports screens of an example embodiment. As shown in FIGS. 5a-n, the user may select to receive information on any of a plurality of sports including, but not limited to autoracing, baseball, basketball, football, golf, hockey, tennis, etc. Additionally, the user may select to receive information of a subcategory (e.g., PGA or LPGA under golf) or other information (schedules, statistics, standings, etc.) of these or other sports categories. User requests may be transmitted to the server 10, which may respond by transmitting the requested information.

In addition, as shown in FIGS. 5o-q, the user may provide interactive data such as voting for a player for the all-star game (i.e., casting an all-star ballot). This is simply one example of the user providing interactive data (e.g., to the content provider) and, in some instances, may be different from providing profile information to the server 10. In this example, the user provided interactive data (e.g., information of the player selected by the user) may be received by the server 10 and subsequently transmitted to another server 15, 17. The server 10 also may transmit user information (e.g., the user's name, address, phone number, email address, age, sex, location information) to the server 15, 17 (retrieved from the user database) along with the user supplied data. The response from said server 15, 17 may be transmitted to server 10 to be forwarded to the set top box 20. As will be evident to those skilled in the art, user provided interactive data is not limited to sports but may have numerous applications.

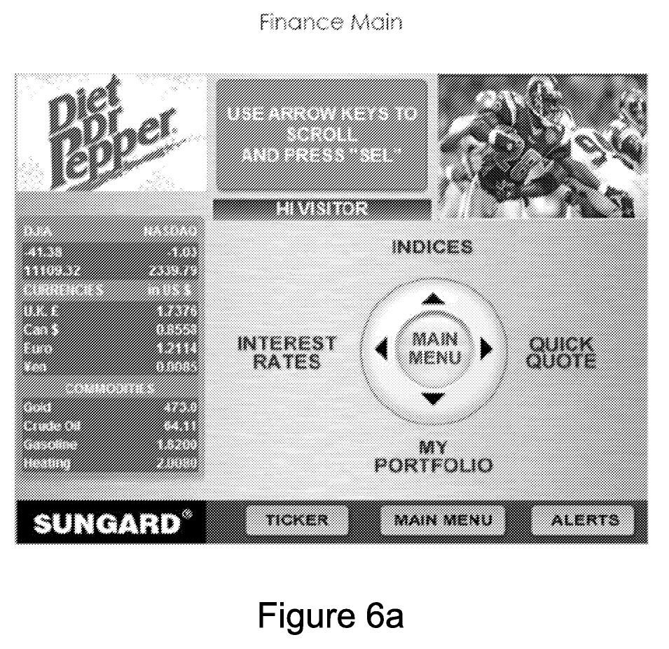

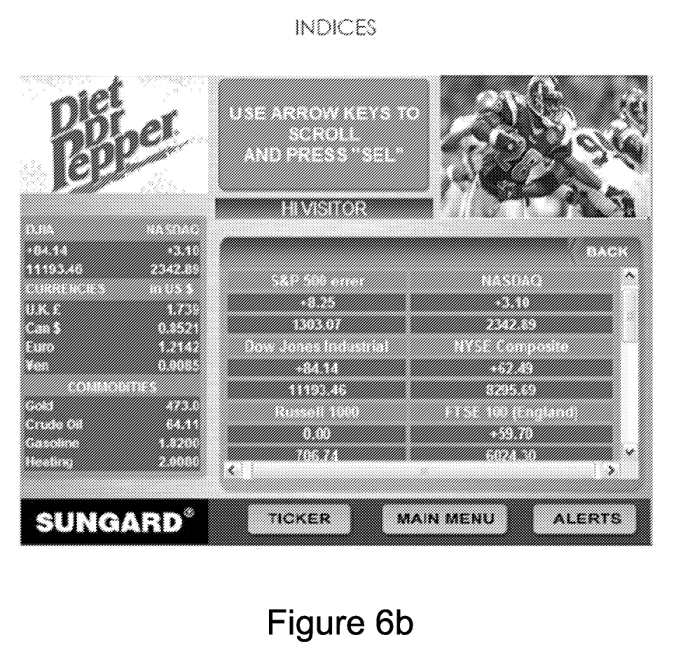

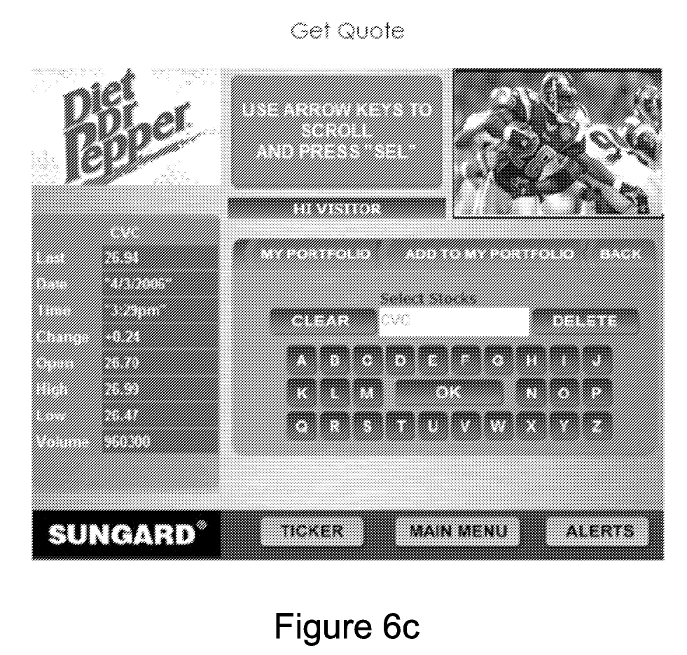

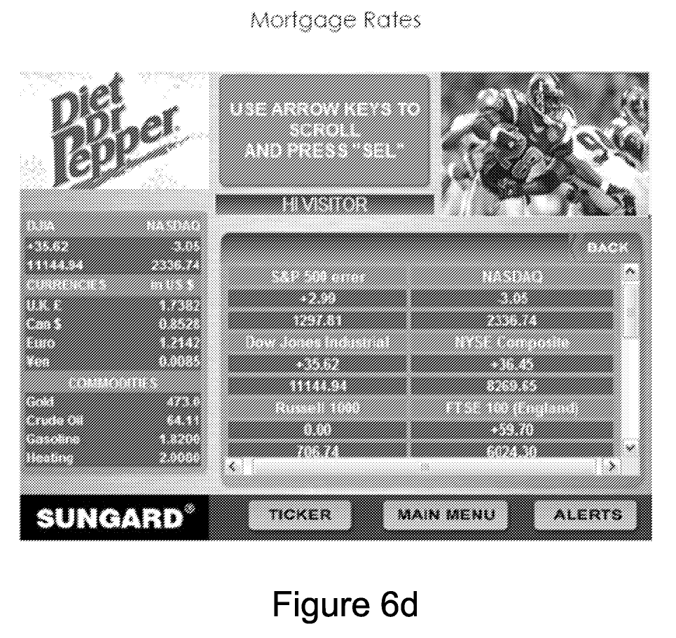

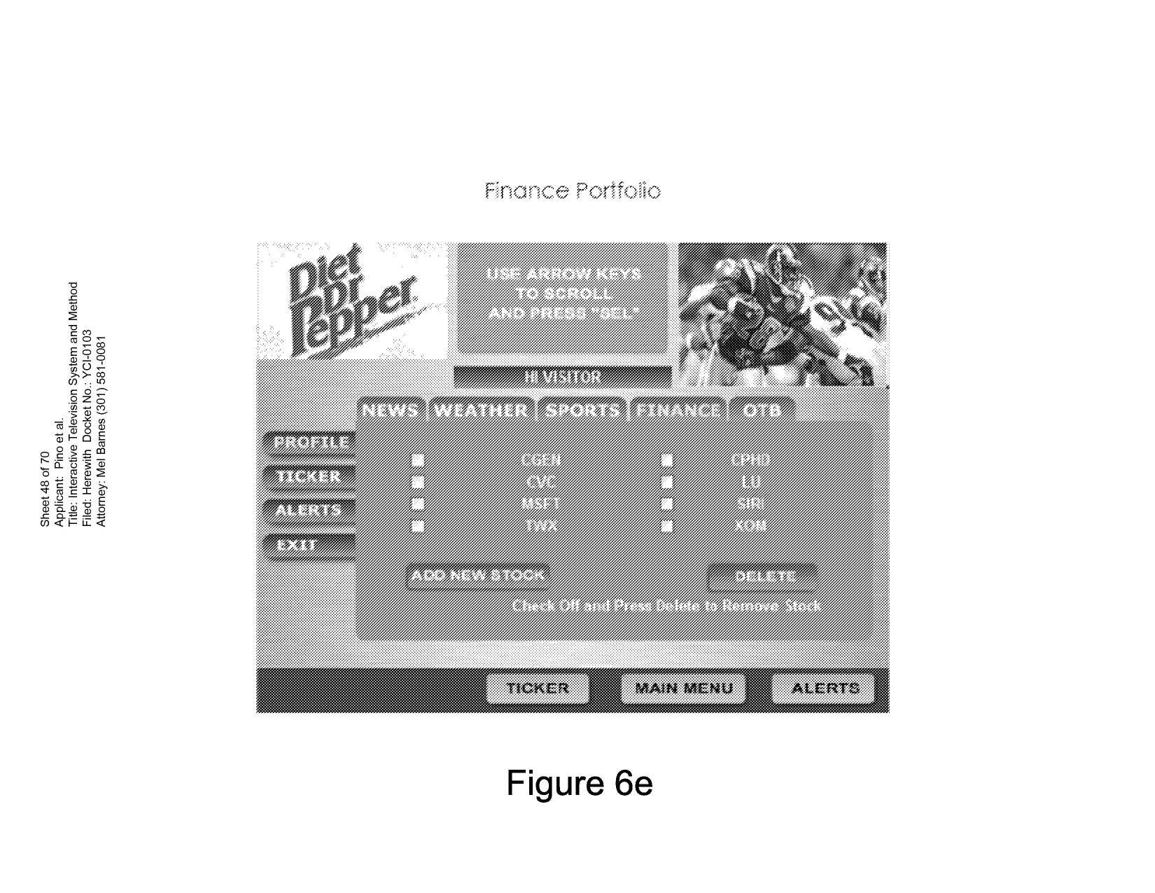

FIGS. 6a-e illustrate how the user may navigate through the finance screens of an example embodiment. The user may select to receive various financial information such as a quote for a particular stock as illustrated by FIG. 6c (or mutual fund or other financial instrument), to view the major indices (see FIG. 6b), to view information of the user's financial portfolio, and/or to change the user's portfolio information (e.g., by adding or deleting stocks) as illustrated by FIG. 6e. Information of the financial instruments (e.g., stock, bonds, mutual funds, commodities, etc.) may be supplied by the user (e.g., via an interface such shown in FIG. 6c) and transmitted to and stored by the server 10 as portfolio information. Thereafter the user may then select My Portfolio from the interface shown in FIG. 6a in order to view quotes and other information on the financial instruments identified by the user. More specifically, when the user selects “My Portfolio” the set top box 20 transmits a request to the server 10 and the server 10 identifies the content to be supplied (by accessing the user database) and retrieves the financial content from memory and/or another server 15, 17 and transmits the financial content to the set top box (as requested). In each instance, as the user requests information, the set top box 20 transmits a request to the server 20, which identifies the needed content by access the user database (if necessary because the needed content is not specified in the received request), collects the needed content, and transmits the content to the set top box 20.

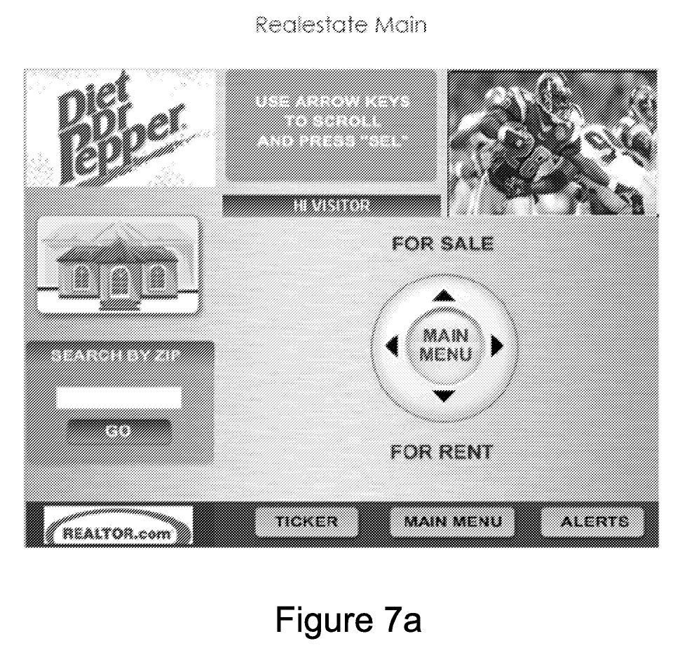

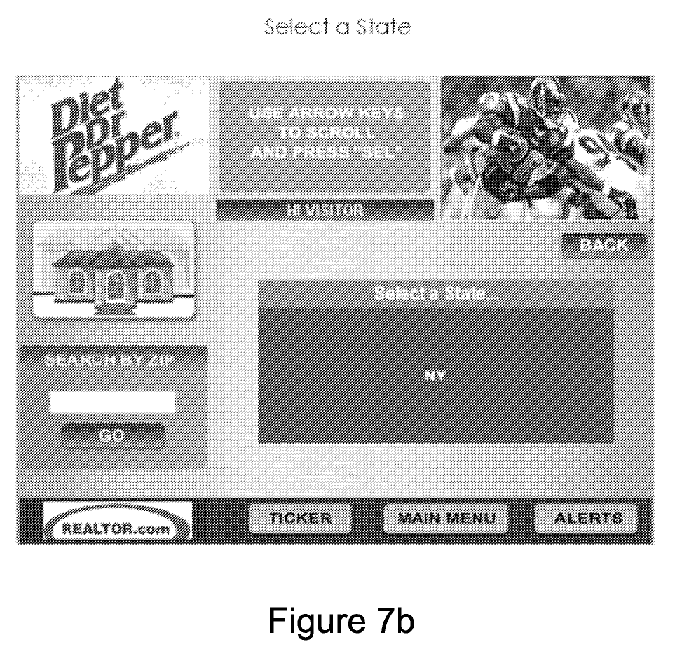

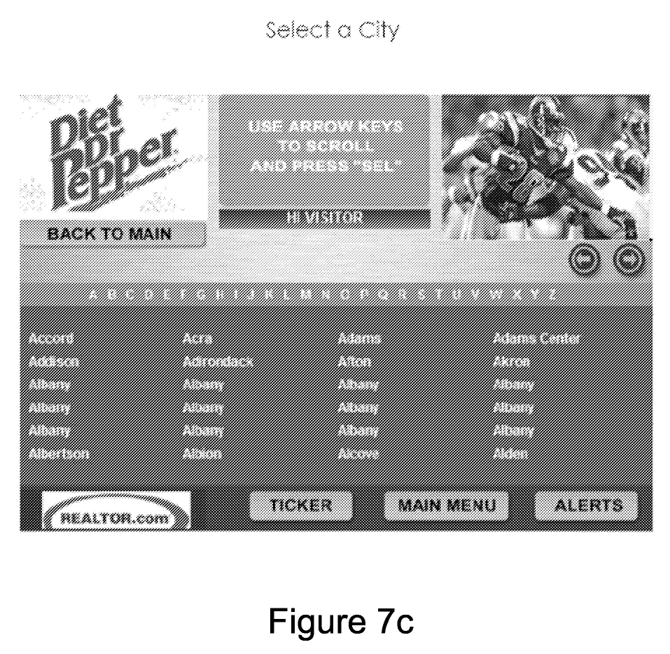

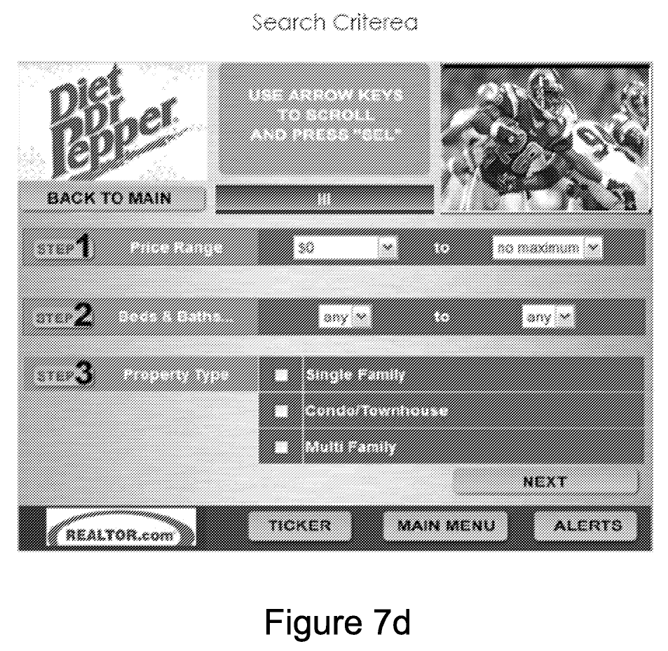

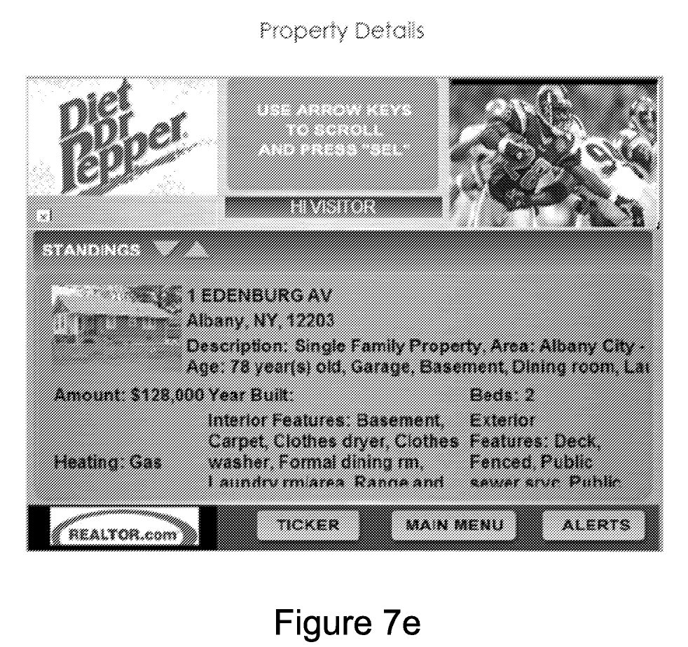

FIGS. 7a-e show how the user may navigate through the real estate screens of an example embodiment. The user may select to receive various real estate information such as information about real estate for sale or rent. Specifically, the user may provide information of the state and city of interest and then provide real estate parameters (e.g., bedrooms, bathrooms, price, property type) for a desired property. The user's real estate information may be transmitted to the server 10. In this example, the user provided interactive real estate data may be received by the server 10 and subsequently transmitted to another server 15, 17. The server 10 may then receive a response from the other server 15, 17 and transmit response information to the user's set top box for display.

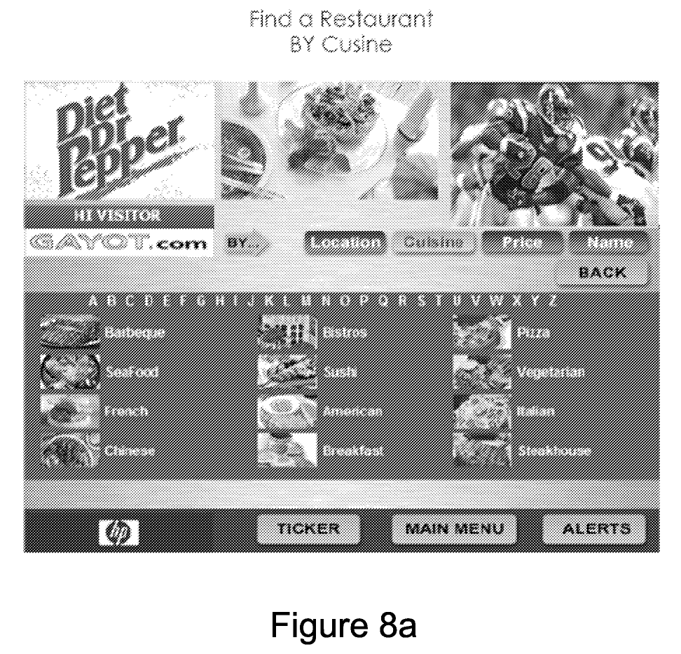

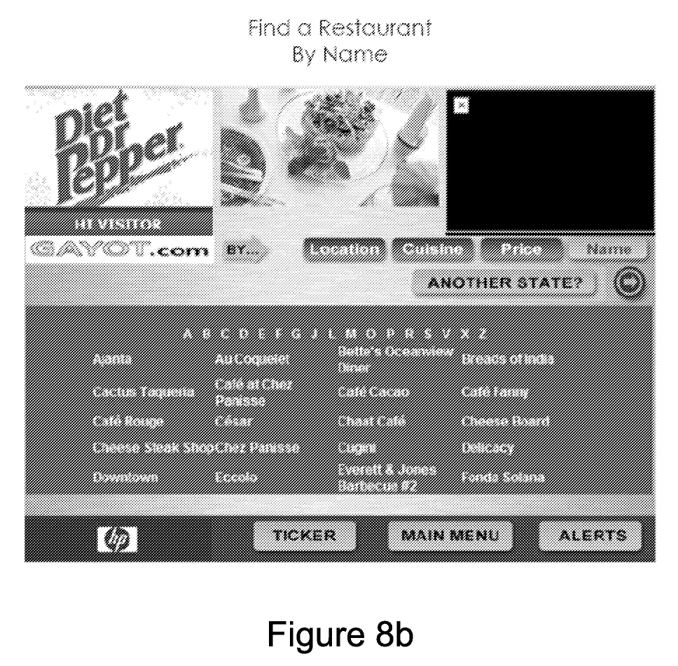

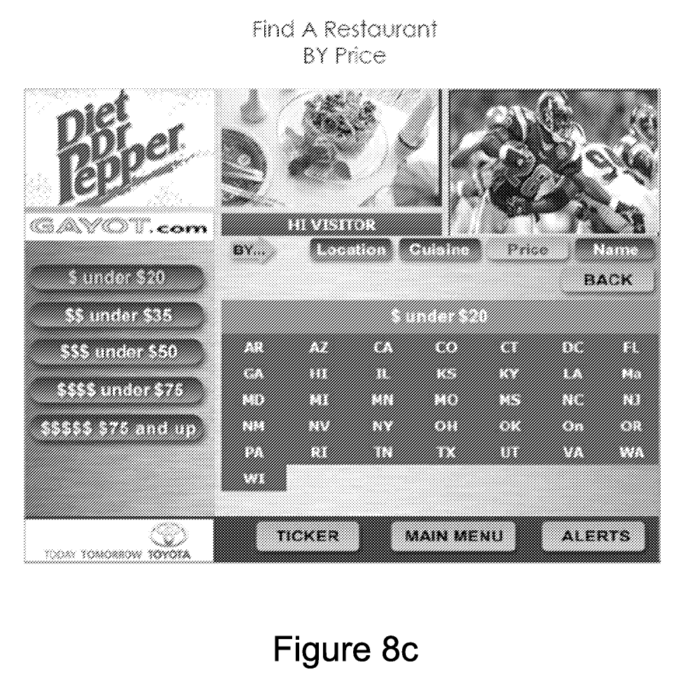

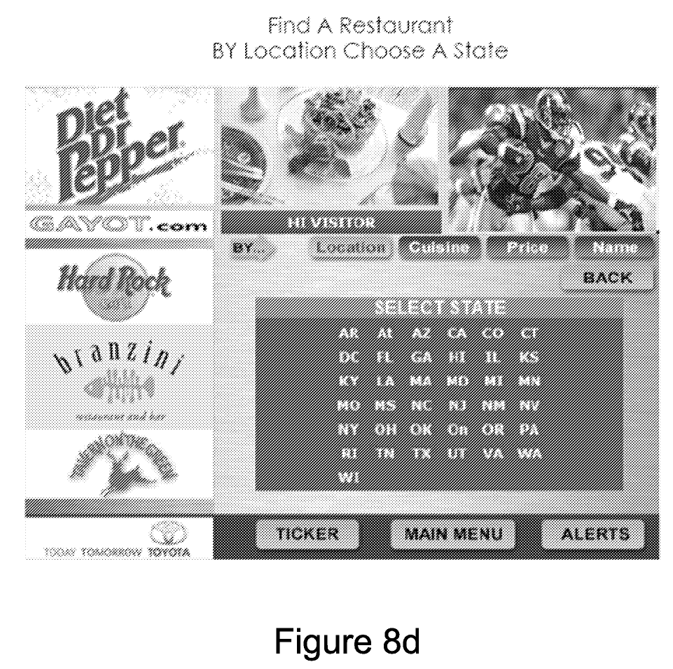

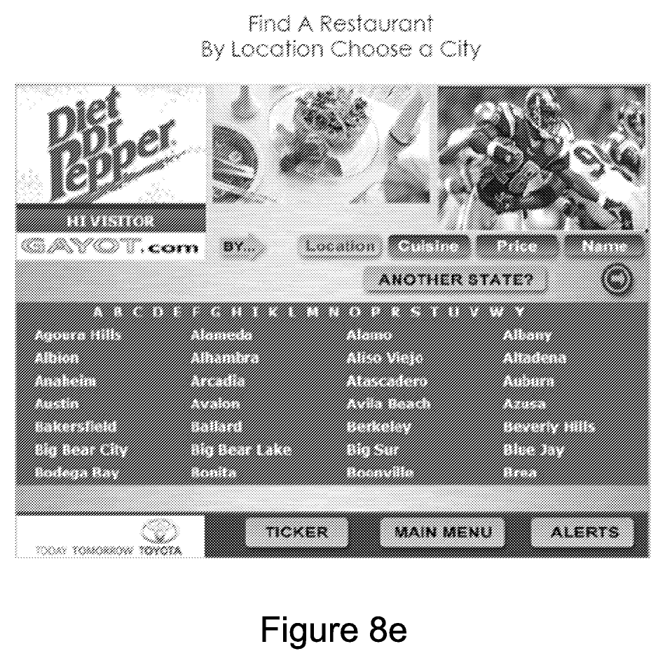

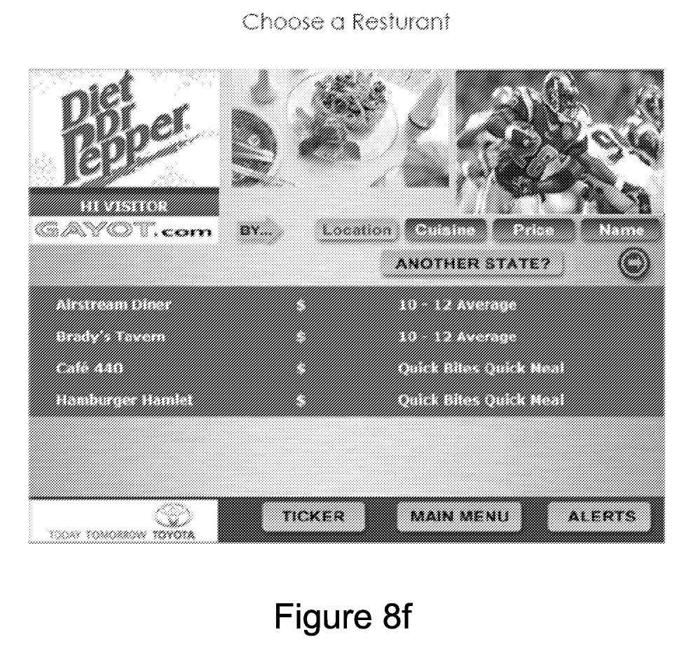

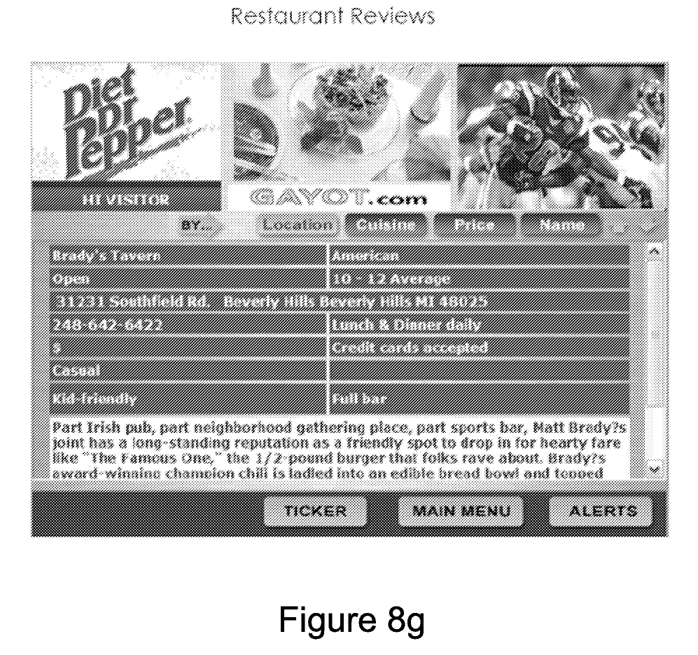

FIGS. 8a-g show interfaces that allow the user to navigate through the restaurant screens of an example embodiment. The user may select to receive information about a restaurant based on location, price, and/or cuisine. The user may also receive reviews of restaurants and select a restaurant to receive further information (e.g., such as telephone number, address) and provide additional information to order food (for delivery or carry out) or to make a reservation. In this example, the user provided interactive restaurant data may be received by the server 10 and subsequently transmitted to another server 15, 17. The server 10 may then receive a response from the other server 15, 17 and transmit response information to the user's set top box 20 for display.

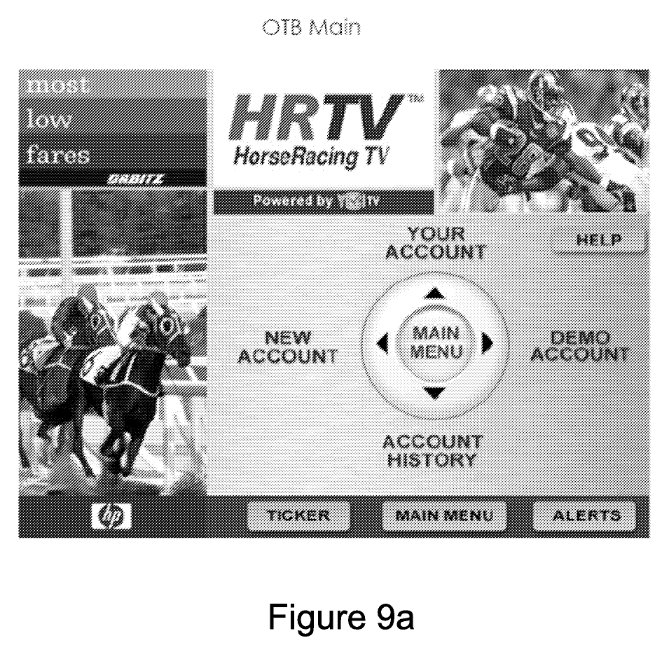

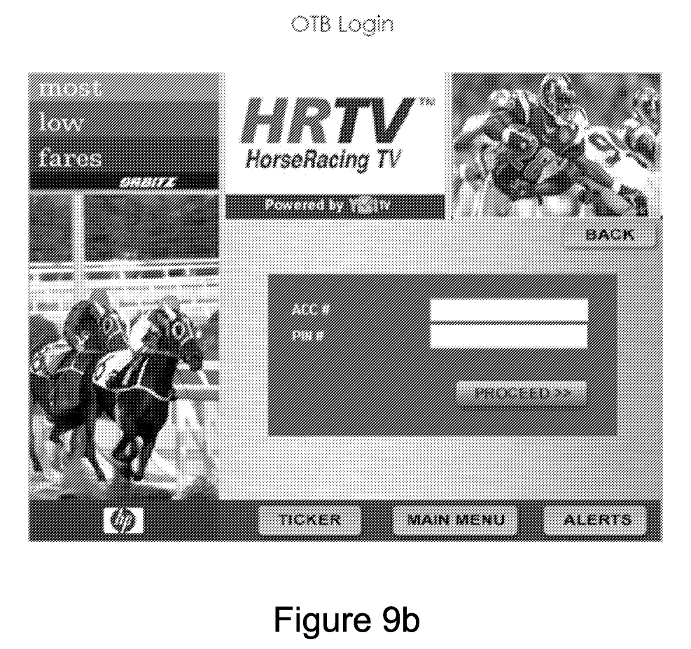

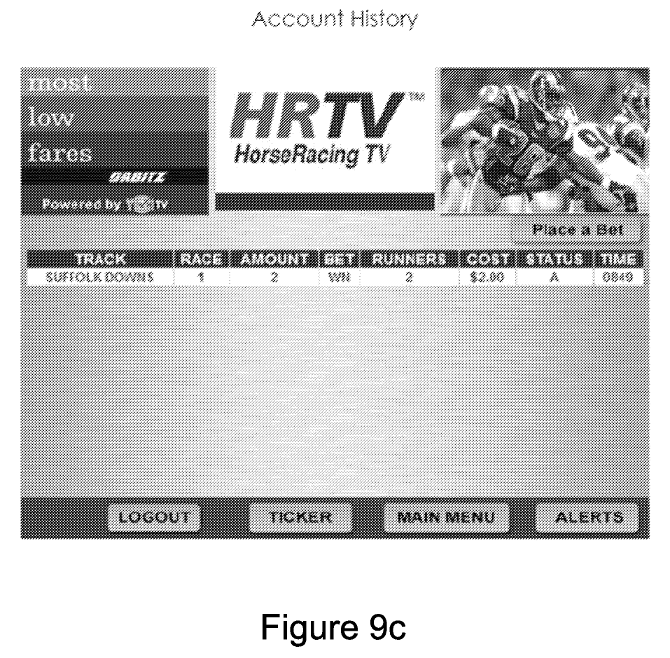

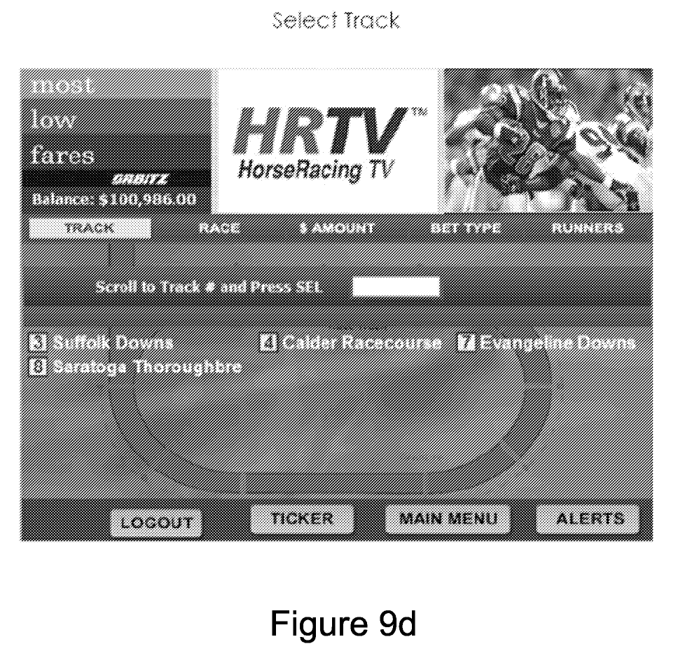

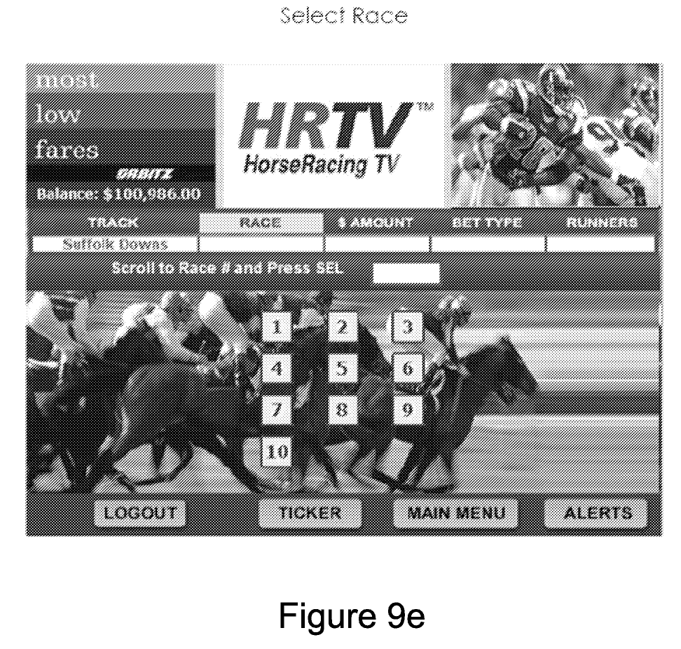

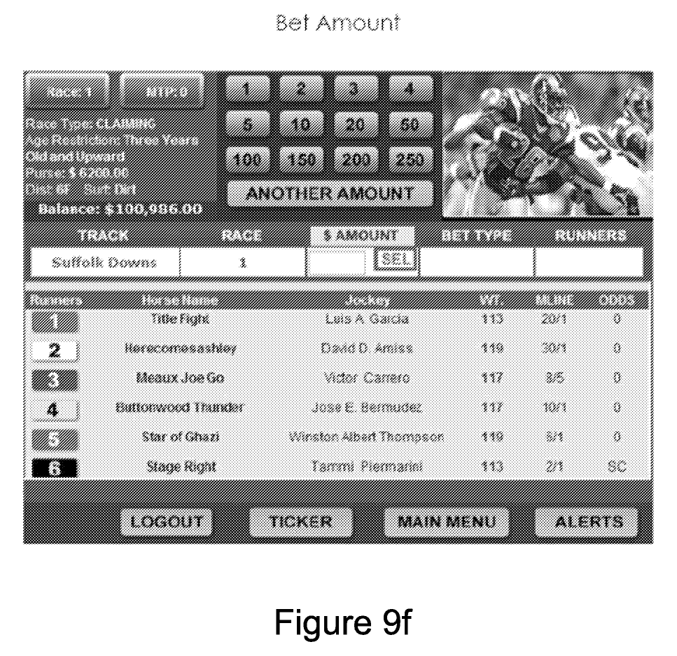

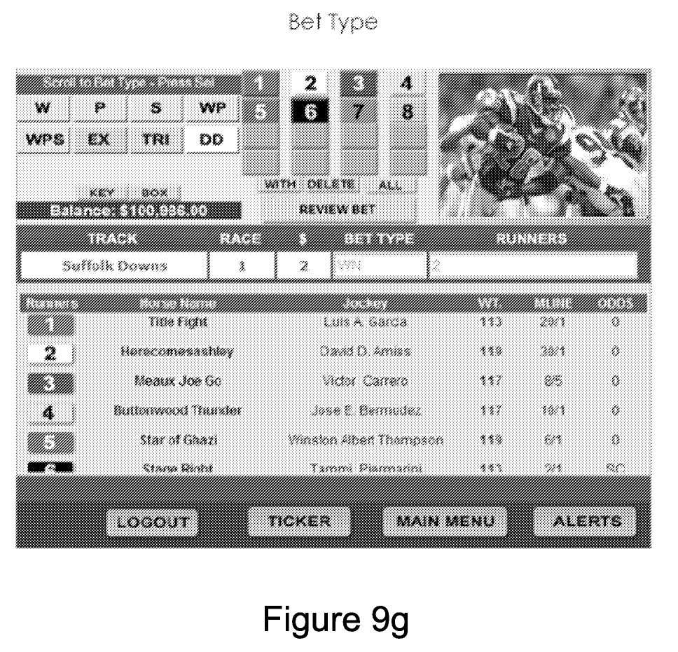

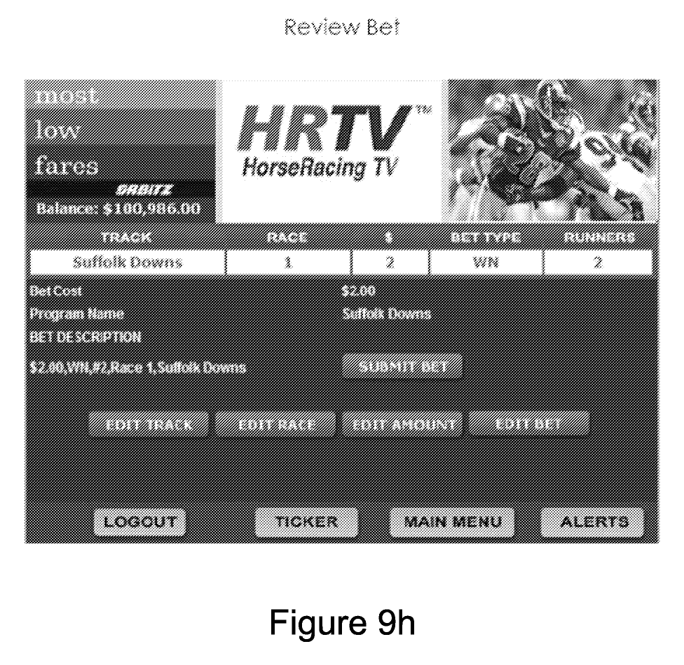

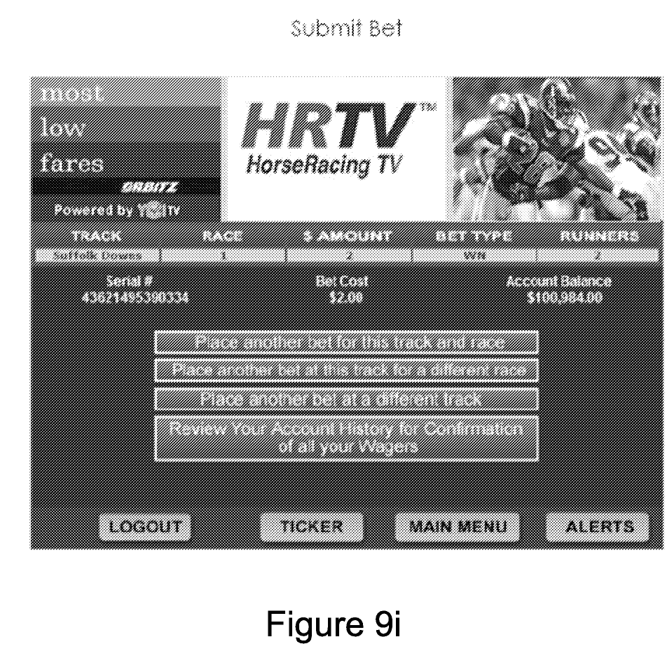

FIGS. 9a-i show how the user may navigate through the wagering screens of an example embodiment (which illustrates an off track betting (OTB) platform although other types of wagering may also be provided). The user may select to open an account, see a demo account, see the user's account history, and/or place bets using the user's account. To place bets or see the account history, the user must login by providing an account number and pin number via the interface of FIG. 9b (which may be different that the user name and password supplied to the set top box). The account number and pin number may be received by the server 10 and verified as valid account information by accessing an OTB database.

The user may select a track via the interface of FIG. 9d, a race number via the interface of FIG. 9e, an amount to bet via the interface of FIG. 9f, a bet type via the interface of FIG. 9g, and then review and submit the bet via the interface of FIG. 9h. The wagering information provided by the user via the interfaces of FIGS. 9d-h may be transmitted to the server 10. In this example, the user provided interactive wagering data may be received by the server 10 and subsequently transmitted to another server 15, 17. The server 10 may then receive a response from the other server 15, 17 and transmit response information to the user's set top box for display. The user may then receive updates (or a live broadcast) of the race.

One of the main issues with any content and transaction service is the level of security. There are various levels of security built in to this example OTB TV Wagering system. The first is in the “front-end” or set-top box, each user must input their account and password to access the system. If the user decides to make a wager, the password must again be supplied, before the wager can be processed. Lack of activity on the service (i.e., no of inputs to the set top box for a predetermined time period) will also prompt a “service time-out”, whereupon re-entry of the password is required to restart the session.

A secure encryption layer is into the set-top box software. Thus, any wagering communication between the set top box and the server (or cable head end) is handled through this software.

When a wager is made by the user, in some embodiments there may be a need for information about the wager to pass through the cable network and into the Tote System, which resides rests outside of the cable network. To facilitate this communication, a VPN or Virtual Private Network, may be set up between the server 20 and the tote company. For example, a “private” telephone line may be used to connect both entities. At each end, the line may be attached to a router, which communicates only with each other, therefore eliminating unwanted third party entrance.

All wagers made by the users also may be recorded by an independent, secure third party depository. Thus, confirmation of the wager from the Tote system is provided to the user (via the server) and also to the third party depository which logs the confirmation. All electronic confirmations are transmitted to and the server 10. Customers may request and receive information of past wagers for up to 30 days after the wager was made via the account history interface of FIG. 9c.

For Customers who desire to “open” an account for wagering through the TV wagering system, an interface with a secure form (https) is provided on-screen (not shown). Information fields will be provided as required by existing OTB rules and regulations. All user input data is encrypted and matched against the user data currently on file with the cable operator to ensure that only cable customers may use the OTB application. Thus, if the data supplied by the user for a new OTB account does not match information from a database of the cable operator that lists the residents at the cable customers, the server 10 may deny the new account.

Existing OTB customers who become cable customer may be required to input their current account number and password to the set top box to be supplied to the server. If requested by OTB, a “Visitor” module may be included to the interface, which allows non-household users to wager through the cable customer's set-top box. In this embodiment, the visitor would register, as set forth in the “Existing Accounts” section, to allow the server 10 to recognize a visitor account.

The user may also fund his or her wagering account via the set top box. Specifically, monies may be transferred to a user's account via secure credit card transaction. An money transfer interface may be provided to the user, which, as with wagers, requires the user enter a password before a transfer can be completed.

There are, in existence, many “Internet” gambling sites which promote and facilitate horse wagering. These sites are commonly accessed through computers, and are open to the public. These sites are neither registered nor sanctioned by State governments. In contrast, the TV Wagering System of the present invention may be a completely closed environment that the public cannot access a home computer. Furthermore, all communications between the server, cable company, and outside sources may be communicated via a highly secure Virtual Private Network (VPN) encryption technologies.

The cable network also may be used to provide wagering via other communication methods. In one example use of the OTB platform, an existing OTB telephone account user wants to make a wager. The user calls from their home phone, which has just been converted to cable VOIP telephone service. The user calls the OTB operator, places the wager, gets a confirmation and hangs up. The user has just used the same data transport mechanism the cable system uses to place the bet. The only difference is that instead of a voice making the wager with an operator, a string of data makes the bet directly with the tote system. This communication, however, may be accomplished via a private and secure network and outside of a PSTN and the internet.

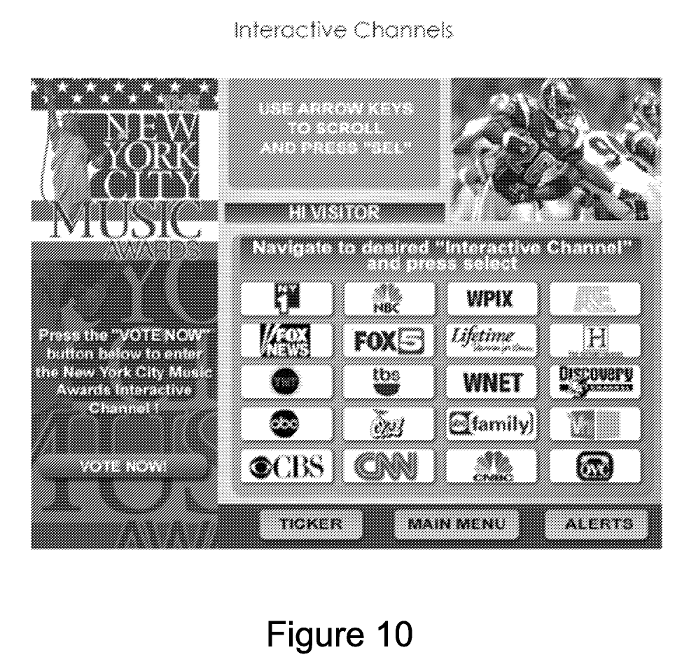

FIG. 10 shows an example of an interactive channel screen which allows the user to select one of a plurality channels. In response to selection of any of the channels, the set top box itself will change the displayed television programming to the selected channel. Thus, this example screen provides an interface for allowing the user to change the television programming.

In another embodiment of the invention (not shown), the user may watch a television program and elect to see multiple choice questions displayed on the screen (e.g., at the top, bottom, or as an overlay). For example, while watching Jeopardy®, another game show (e.g., Name that Tune, Wheel of Fortune, Who Wants to Be a Millionaire®, etc.) or other type of show, the user may elect to see multiple choice questions (or questions in another format) that correspond to the question asked of the contestants on the television program. The user may answer the questions via the input device. The set top box 20 may then transmit the user responses to the server 10, which may transmit the data to another server 15, 17, either of which may tally the scores of all the users competing. The multiple choice or other game data may be sent in the vertical blanking interval or via other suitable means.

Thus, the present invention may be used to facilitate and/or implement advertising (including but not limited to, interactive and non-interactive being related or unrelated to the program content), wagering (including but not limited to horse wagering, baseball, football, basketball, hockey, tennis, golf, car racing, dog races, soccer, lacrosse and all fantasy sports games (including but not limited to horse wagering, baseball, football, basketball, hockey, tennis, golf, car racing, dog races, soccer, lacrosse). In addition, one or more embodiments may be used to facilitate and/or implement purchase transactions (buy and/or sell), and other transactions (exchange products/services, get information, post information, etc.) or applications not necessarily related to sports (including fantasy sports) such as financial transactions, weather, news, food, dining, beverages (alcoholic and non-alcoholic), personals, real estate, automotive, travel, entertainment, music, lottery, and games (e.g., interactive gaming, including participating in, which may include wagering), but not limited to, all forms of card games (such as poker, blackjack, solitaire, baccarat, pinochle, gin, rummy) slot games, trivia, games of chance, roulette, keno, slingo, bingo, name that tune, wheel of fortune, dominions, dice (craps) where individuals or groups can participate and compete against one another.

In addition, one or more embodiments may be used to facilitate and/or implement the purchase or exchange of music or video (files or data) between video (and/or audio) storage devices for personal, commercial, hotels, residential buildings and communities or home use, including but not limited to MP3 players, iPods®, PDAs etc. Many set top boxes include USB ports, to which a storage device may be connected to receive (or provide) the data or files (e.g., received and purchased from itunes® via an advertisement displayed on a screen).

While the present invention has been described in the context of a cable television system, one or more embodiments may be modified by one skilled in the art to function in other telecommunications networks, including interactive and non-interactive broadcasting, programming, and infrastructure services, and applications to mobile telephone networks (e.g., cellular telephones), DBS satellite networks, microwave systems, DBS satellite systems, PDA networks (e.g., Blackberry® network), WiFi networks, WiMax networks, future version of these networks, and other networks, and employ their associated products including their web servers, computer systems, and all related forms of communication devices and media including but not limited to DSL, T1, T3, OC3, HFC, Fios, Lightspeed, Fiber, coax cable, and copper.

Thus, operation of the server may be accomplished via a server-based application platform for interactive television that “acts” as an EPG (electronic program guide) for interactive channels. In one example embodiment, the interactive channels and/or interactive advertisements (e.g., commercials) may be created (or communicated) using the cable provider's sidebands. The server application may include coding or scripting to facilitate the timing mechanisms used to coordinate (e.g., synchronize presentation of) advertising and/or interactivity (with each other or with television programming). In addition, an “A-sync” purchasing mechanism may be used to provide the user with one ID and password for transacting (e.g., buy, sell, exchange) throughout the network services, interactive channels and interactive commercials. This method may allow the cable provider company to be taken out of the transaction loop.

In some embodiments, a monitor or computer system (with a display device) may act as a television and provide the presentation of the television programming and interfaces to the user. Thus, while the embodiments herein are described in the context of a set top box other devices can be used to implement various embodiments of the present invention. The term set-top box generally is used to describe a device that connects to a television and some external source of signal, and converts the signal into content that can be displayed on the display. The signal source might be an Ethernet cable, a satellite dish, a coaxial cable, a telephone line (including DSL connections), Broadband over Power Line, or even an ordinary VHF or UHF antenna. A set top box connected to a television's (or video recorder device's) input connector typically feeds a baseband television signal and may act as the television's tuner (allowing the user to select the television programming). In addition, the set top box may act as a video recording device. In addition, in some embodiments the set top box also may be integrated into the television of other display device (e.g., a computer connected to a cable modem, satellite receiver, or the internet). However, it will be evident to those skilled in the art that the present invention is not limited to a set top box but would work equally as well via hardware and software embodied in, or as, other devices.

In some instances, the pulled data or pushed data may be communicated over a data path that includes a public data network (e.g., the internet) or a private network (e.g., VPN). For example, in one embodiment, pulled data is received via the Internet and the pushed data is received via a private network.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing television programming content and interactive data services via a plurality of communication devices disposed in a plurality of customer premises and that are configured to cause a display device to display television programming content and interactive content, comprising:
storing user account information for each of a plurality of user accounts, including user account identifying information, in a memory; in association with a communication device;
wherein multiple user accounts are associated with a plurality of the communication devices;
receiving user profile information of one or more user profiles from a plurality of the communication devices;
wherein each user profile information includes one or more content selections associated with a user account; and
storing each of the received user profile information in memory in association with a user account.

2. The method of claim 1, further comprising:
receiving a request for content from a communication device;
determining a user account associated with the request;
determining first content based on the content selections stored in memory associated with the user account; and
transmitting the first content to the communication device.

3. The method of claim 2, wherein the request includes information identifying the communication device and determining a user account associated with the request comprises retrieving the user account associated with the communication device.

4. The method of claim 2, wherein the request includes information identifying the user account and determining a user account associated with the request comprises extracting data of the user account from the request.

5. The method of claim 2, further comprising:
transmitting a request for the first content; and
receiving the first content.

6. The method of claim 2, further comprising:
receiving pushed content that includes the first content;
storing the first content in memory; and
retrieving the first content from memory.

7. The method of claim 1, further comprising:
receiving ticker information from a plurality of the communication devices;
storing each of the received ticker information in memory in association with a user account; and
wherein ticker information includes one or more selections of content for display on the display device concurrently with the television programming content.

8. The method of claim 7, further comprising:
receiving a request for ticker content from a user account;
determining the ticker content requested based on the ticker information stored in memory for the user account;
transmitting one or more requests for ticker content;
receiving ticker content in response to the one or more transmitted requests for ticker content; and
transmitting the received ticker content to a communication device.

9. The method of claim 7, further comprising:
receiving pushed content;
storing the pushed content;
selecting pushed content based on the ticker information stored in memory; and
transmitting the selected pushed content to a communication device.

10. The method of claim 7, wherein the communication device causes ticker content to be displayed on the display until receiving a user actuation.

11. The method of claim 1, further comprising:
receiving alert information from a plurality of the communication devices; and
storing each of the received alert information in memory in association with a user account.

12. The method of claim 11, further comprising:
receiving a request for alert content from a user account;
determining the alert content requested based on the alert information stored in memory for the user account;
transmitting one or more requests for alert content;
receiving content in response to the one or more transmitted requests for alert content; and
transmitting the received alert content to a communication device.

13. The method of claim 12, further comprising determining that the received content has not been previously transmitted to the communication device.

14. The method of claim 11, further comprising:
receiving pushed content;
storing the pushed content;
selecting pushed content based on the alert information stored in memory; and
transmitting the selected pushed content to one or more communication devices.

15. The method of claim 1, further comprising:
storing user information in memory in association with a user account;
selecting an advertisement based on user information associated with the user account; and
transmitting the advertisements to the communication device associated with the user account.

16. The method of claim 1, wherein the one or more content selections comprise selections of one or more content sources.

17. A method of providing television programming content and interactive data services via a plurality of communication devices disposed in a plurality of customer premises and that are configured to cause a display device to display television programming content and interactive content, comprising:
storing user account information for each of a plurality of user accounts, including user account identifying information, in a memory; in association with a communication device;
receiving user profile information of one or more user profiles from a plurality of the communication devices;
wherein each user profile information includes one or more content selections associated with a user account;
storing each of the received user profile information in memory in association with a user account;
receiving a request for content from a communication device;
determining a user account associated with the request;
determining first content based on the content selections stored in memory associated for the user account; and
transmitting the first content to the communication device.

18. The method of claim 17, wherein the request includes information identifying the communication device and determining a user account associated with the request comprises retrieving the user account associated with the communication device.

19. The method of claim 17, wherein the request includes information identifying the user account and said determining a user account associated comprises extracting data of the user account from the request.

20. The method of claim 17, further comprising:
transmitting a request for the first content; and
receiving the first content.

21. The method of claim 17, further comprising:
receiving pushed content that includes the first content;
storing the first content in memory; and
retrieving the first content from memory.

22. The method of claim 17, further comprising:
receiving alert information from a plurality of the communication devices; and
storing each of the received alert information in memory in association with a user account.

23. The method of claim 22, further comprising:
receiving a request for alert content from a user account;
determining the alert content requested based on the alert information stored in memory for the user account;
transmitting one or more requests for alert content;
receiving content in response to the one or more transmitted requests for alert content; and
transmitting the received alert content to a communication device.

24. The method of claim 23, further comprising determining that the received content has not been previously transmitted to the communication device.

25. The method of claim 22, further comprising:
receiving pushed content;
storing the pushed content;
selecting pushed content based on the alert information in memory; and
transmitting the selected pushed content to one or more communication devices.

26. The method of claim 17, further comprising:
storing user information in memory in association with a user account;
selecting an advertisement based on user information associated with a user account; and
transmitting the advertisements to the communication device associated with the user account.

27. The method of claim 17, wherein the one or more content selections comprise selections of one or more content sources.

28. A method of providing interactive data services and television programming to a plurality of set top boxes configured to receive television programming via a data network, the method comprising:
receiving the ticker information and alert information from a plurality of set top boxes;
storing the ticker information and the alert information in association with a user account in memory;
receiving requests for ticker content from a first set of the set top boxes;
determining a user account associated with each of the requests for ticker content;
receiving requests for alert content from a second set of the set top boxes;
determining a user account associated with each of the requests for alert content;
retrieving the stored ticker information for the user accounts associated with the requests for ticker content;
retrieving the stored alert information for the user accounts associated with the requests for alert content;
transmitting one or more requests for content based on the retrieved ticker information and alert information;
receiving requested content in response to the requests for content;
storing the requested content;
receiving pushed content;
storing the pushed content;
for each set top box of the first set of set top boxes, selecting first content from the requested content and from the pushed content according to the retrieved ticker information;
for each set top box of the first set of set top boxes, transmitting the selected first content to the set top box;
for each set top box of the second set of set top boxes, selecting second content from the pushed content and the pulled content according to the retrieved alert information; and
for each set top box of the second set of set top boxes, transmitting the selected second content to the set top box.

29. The method of claim 28, further comprising:
at each set top box of the second set of set top receiving the second content and displaying the second content on a display concurrently with television programming content, followed by terminating display of the second content after a time period.

30. The method of claim 28, further comprising:
at each of the first set of set top boxes,
receiving the first content; and
displaying the first content on a television connected to the set top box.

31. The method of claim 28, further comprising:
at each set top box of the first set of set top boxes, receiving and displaying the first content on a display concurrently with television program content and terminating said displaying in accordance with a user action.
